(19) United States
(12) Patent Application Publication
(10) Pub. No.: US 2024/0014924 A1
(43) Pub. Date: Jan. 11, 2024

(54) DYNAMIC REPORTING OF MULTI-LEVEL CODING CONFIGURATIONS

(71) Applicant: QUALCOMM Incorporated, San Diego, CA (US)

(72) Inventors: Shay Landis, Hod Hasharon (IL); Idan Michael Horn, Hod Hasharon (IL); Daniel Paz, Geva Carmel (IL)

(21) Appl. No.: 17/857,734

(22) Filed: Jul. 5, 2022

(51) Int. Cl. H04L 1/00

(52) U.S. Cl. CPC H04L 1/0009

(57) ABSTRACT

Methods, systems, and devices for wireless communications are described. A wireless device such as a user equipment (UE) may receive a message that indicates a coding procedure such as a multi-level coding (MLC) procedure to implement for ongoing communications. The UE may select a first code rate indicator value from a plurality of code rate indicator values corresponding to a first code rate for a first coding level of the coding procedure, and may select a second code rate indicator value that corresponds to a second code rate for a second coding level of the coding procedure. The UE may then transmit a coding level indicator report which includes the selected first code rate indicator value and second code rate indicator value. Based on the transmitted coding level indicator report, the UE may communicate at least one data packet using the coding procedure and the first and second code rates.

### FIELD OF TECHNOLOGY

The following relates to wireless communications, including dynamic reporting of multi-level coding (MLC) configurations.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support dynamic reporting of multi-level coding (MLC) configurations. For example, the described techniques provide support for various different modulation and coding procedures that provide different levels of error-protection for encoded transmissions. To reduce power consumption, devices may perform different types of coding procedures, such as MLC, where encoding and decoding may be split into multiple levels such that different component codes (e.g., code rates, modulation orders, or both) are applied to non-overlapping sets of bits. To perform MLC, a wireless device may select, for each level of code, a code rate indicator value such as a channel quality indicator (CQI) index which corresponds to a modulation order and a coding scheme.

To report CQI more efficiently to select modulation order and coding rate values for MLC, the wireless device may select and report one CQI value per code level of the MLC procedure. For example, for a first coding level, the wireless device may select a first CQI index associated with a first modulation order and first coding rate from a first CQI table. For a second coding level the wireless device may select a second CQI index associated with a second coding rate from a second CQI table. The wireless device may report the selected CQI indices in a coding level indicator report and may receive subsequent control signaling from the network indicating which CQI indices are selected and which corresponding modulation and coding scheme (MCS) values to use for each level of MLC.

A method for wireless communication at a user equipment (UE) is described. The method may include receiving a message indicating a coding procedure for communications associated with the UE, transmitting a coding level indicator report including a set of multiple code rate indicator values associated with the coding procedure, where a first code rate indicator value of the set of multiple code rate indicator values corresponds to a first code rate for a first coding level of the coding procedure, and where a second code rate indicator value of the set of multiple code rate indicator values corresponds to a second code rate for a second coding level of the coding procedure, and communicating at least one data packet using the coding procedure based on the coding level indicator report.

An apparatus for wireless communication at a UE is described. The apparatus may include a processor, memory coupled with the processor, and instructions stored in the memory. The instructions may be executable by the processor to cause the apparatus to receive a message indicating a coding procedure for communications associated with the UE, transmit a coding level indicator report including a set of multiple code rate indicator values associated with the coding procedure, where a first code rate indicator value of the set of multiple code rate indicator values corresponds to a first code rate for a first coding level of the coding procedure, and where a second code rate indicator value of the set of multiple code rate indicator values corresponds to a second code rate for a second coding level of the coding procedure, and communicate at least one data packet using the coding procedure based on the coding level indicator report.

Another apparatus for wireless communication at a UE is described. The apparatus may include means for receiving a message indicating a coding procedure for communications associated with the UE, means for transmitting a coding level indicator report including a set of multiple code rate indicator values associated with the coding procedure, where a first code rate indicator value of the set of multiple code rate indicator values corresponds to a first code rate for a first coding level of the coding procedure, and where a second code rate indicator value of the set of multiple code rate indicator values corresponds to a second code rate for a second coding level of the coding procedure, and means for communicating at least one data packet using the coding procedure based on the coding level indicator report.

A non-transitory computer-readable medium storing code for wireless communication at a UE is described. The code may include instructions executable by a processor to receive a message indicating a coding procedure for communications associated with the UE, transmit a coding level indicator report including a set of multiple code rate indicator values associated with the coding procedure, where a first code rate indicator value of the set of multiple code rate indicator values corresponds to a first code rate for a first coding level of the coding procedure, and where a second code rate indicator value of the set of multiple code rate indicator values corresponds to a second code rate for a second coding level of the coding procedure, and communicate at least one data packet using the coding procedure based on the coding level indicator report.

Some examples of the method, apparatuses, and non-transitory computer-readable medium described herein may further include operations, features, means, or instructions for selecting the first code rate indicator value of the set of multiple code rate indicator values and the second code rate indicator value of the set of multiple code rate indicator values based on a spectral efficiency value for communicating the at least one data packet, a power consumption value for communicating the at least one data packet, or both and communicating the at least one data packet using the coding procedure in accordance with the selected first code rate indicator value and the selected second code rate indicator value.

Some examples of the method, apparatuses, and non-transitory computer-readable medium described herein may further include operations, features, means, or instructions for selecting the first code rate indicator value and the second code rate indicator value based on the spectral efficiency value satisfying a spectral efficiency threshold and the power consumption value satisfying a power consumption threshold for the coding procedure.

In some examples of the method, apparatuses, and non-transitory computer-readable medium described herein, different combinations of the first code rate indicator value of the set of multiple code rate indicator values and the second code rate indicator value of the set of multiple code rate indicator values correspond to different spectral efficiency values and different power consumption values.

In some examples of the method, apparatuses, and non-transitory computer-readable medium described herein, communicating the at least one data packet may include operations, features, means, or instructions for encoding or decoding a first subset of bits of the at least one data packet in accordance with the first code rate for the first coding level of the coding procedure and encoding or decoding a second subset of bits of the at least one data packet in accordance with the second code rate for the second coding level of the coding procedure.

Some examples of the method, apparatuses, and non-transitory computer-readable medium described herein may further include operations, features, means, or instructions for selecting the first code rate indicator value of the set of multiple code rate indicator values from a first CQI table, the first CQI table including the set of multiple code rate indicator values associated with the first coding level, a first set of one or more corresponding modulation orders, a first set of one or more corresponding code rates, or any combination thereof and selecting the second code rate indicator value of the set of multiple code rate indicator values from a second CQI table, the second CQI table including the set of multiple code rate indicator values associated with the second coding level, and a second set of one or more corresponding code rates.

In some examples of the method, apparatuses, and non-transitory computer-readable medium described herein, the first CQI table and the second CQI table may have a different quantity of rows and columns based on the first coding level and the second coding level.

Some examples of the method, apparatuses, and non-transitory computer-readable medium described herein may further include operations, features, means, or instructions for selecting the first code rate indicator value of the set of multiple code rate indicator values from a first CQI table, the first CQI table including the set of multiple code rate indicator values associated with the first coding level and a first set of corresponding code rates, selecting the second code rate indicator value of the set of multiple code rate indicator values from a second CQI table, the second CQI table including the set of multiple code rate indicator values associated with the second code rate, and a second set of one or more corresponding code rates, and selecting a third code rate indicator value from a third CQI table, the third CQI table including a modulation order associated with the first code rate indicator value and the second code rate indicator value.

In some examples of the method, apparatuses, and non-transitory computer-readable medium described herein, the first CQI table, the second CQI table, and the third CQI table may have a different quantity of rows and columns based on the first coding level and the second coding level.

Some examples of the method, apparatuses, and non-transitory computer-readable medium described herein may further include operations, features, means, or instructions for receiving, in response to the coding level indicator report, one or more control messages that indicate a set of code rate indicator values for the UE to use, the set of code rate indicator values corresponding to the first code rate for the first coding level of the coding procedure and to the second code rate for the second coding level of the coding procedure.

In some examples of the method, apparatuses, and non-transitory computer-readable medium described herein, the one or more control messages include a downlink control information (DCI) message, a medium access control-control element (MAC-CE), a radio resource control (RRC) message, or any combination thereof.

Some examples of the method, apparatuses, and non-transitory computer-readable medium described herein may further include operations, features, means, or instructions for receiving the one or more control messages that indicate the set of code rate indicator values based on a reporting granularity associated with the first code rate and the second code rate.

In some examples of the method, apparatuses, and non-transitory computer-readable medium described herein, the coding level indicator report includes a CQI report, a precoding matrix indicator (PMI) report, or a rank indicator (RI) report.

In some examples of the method, apparatuses, and non-transitory computer-readable medium described herein, the coding procedure includes a MLC procedure.

A method for wireless communication at a network entity is described. The method may include transmitting a message indicating a coding procedure for communications associated with a UE, receiving, from the UE, a coding level indicator report including a set of multiple code rate indicator values associated with the coding procedure, where a first code rate indicator value of the set of multiple code rate indicator values corresponds to a first code rate for a first coding level of the coding procedure, and where a second code rate indicator value of the set of multiple code rate indicator values corresponds to a second code rate for a second coding level of the coding procedure, and communicating at least one data packet based on the coding level indicator report.

An apparatus for wireless communication at a network entity is described. The apparatus may include a processor, memory coupled with the processor, and instructions stored in the memory. The instructions may be executable by the processor to cause the apparatus to transmit a message indicating a coding procedure for communications associated with a UE, receive, from the UE, a coding level indicator report including a set of multiple code rate indicator values associated with the coding procedure, where a first code rate indicator value of the set of multiple code rate indicator values corresponds to a first code rate for a first coding level of the coding procedure, and where a second code rate indicator value of the set of multiple code rate indicator values corresponds to a second code rate for a second coding level of the coding procedure, and communicate at least one data packet based on the coding level indicator report.

Another apparatus for wireless communication at a network entity is described. The apparatus may include means for transmitting a message indicating a coding procedure for communications associated with a UE, means for receiving, from the UE, a coding level indicator report including a set of multiple code rate indicator values associated with the coding procedure, where a first code rate indicator value of the set of multiple code rate indicator values corresponds to a first code rate for a first coding level of the coding procedure, and where a second code rate indicator value of the set of multiple code rate indicator values corresponds to a second code rate for a second coding level of the coding procedure, and means for communicating at least one data packet based on the coding level indicator report.

A non-transitory computer-readable medium storing code for wireless communication at a network entity is described. The code may include instructions executable by a processor to transmit a message indicating a coding procedure for communications associated with a UE, receive, from the UE, a coding level indicator report including a set of multiple code rate indicator values associated with the coding procedure, where a first code rate indicator value of the set of multiple code rate indicator values corresponds to a first code rate for a first coding level of the coding procedure, and where a second code rate indicator value of the set of multiple code rate indicator values corresponds to a second code rate for a second coding level of the coding procedure, and communicate at least one data packet based on the coding level indicator report.

In some examples of the method, apparatuses, and non-transitory computer-readable medium described herein, communicating the at least one data packet may include operations, features, means, or instructions for encoding or decoding a first subset of bits of the at least one data packet in accordance with the first code rate for the first coding level of the coding procedure and encoding or decoding a second subset of bits of the at least one data packet in accordance with the second code rate for the second coding level of the coding procedure.

Some examples of the method, apparatuses, and non-transitory computer-readable medium described herein may further include operations, features, means, or instructions for selecting a first set of one or more modulation orders and a first set of one or more code rates for the first coding level, selecting a second set of one or more modulation orders and a second set of one or more code rates for the second coding level, and transmitting an indication of the first set of one or more modulation orders for the first coding level, the first set of one or more code rates for the first coding level, the second set of one or more modulation orders for the second coding level, the second set of one or more code rates for the second coding level, or any combination thereof.

Some examples of the method, apparatuses, and non-transitory computer-readable medium described herein may further include operations, features, means, or instructions for encoding or decoding at least one data packet in accordance with the first set of one or more modulation orders for the first coding level, the first set of one or more code rates for the first coding level, the second set of one or more modulation orders for the second coding level, the second set of one or more code rates for the second coding level, or any combination thereof.

Some examples of the method, apparatuses, and non-transitory computer-readable medium described herein may further include operations, features, means, or instructions for transmitting, in response to the coding level indicator report, one or more control messages that indicate a set of code rate indicator values for the UE to use, the set of code rate indicator values corresponding to the first code rate for the first coding level of the coding procedure and to the second code rate for the second coding level of the coding procedure.

In some examples of the method, apparatuses, and non-transitory computer-readable medium described herein, the one or more control messages include a DCI message, a MAC-CE, an RRC message, or any combination thereof

Some examples of the method, apparatuses, and non-transitory computer-readable medium described herein may further include operations, features, means, or instructions for transmitting the one or more control messages that indicate the set of code rate indicator values based on a reporting granularity associated with the first code rate and the second code rate.

In some examples of the method, apparatuses, and non-transitory computer-readable medium described herein, the coding level indicator report includes a CQI report, a PMI report, or an RI report.

In some examples of the method, apparatuses, and non-transitory computer-readable medium described herein, the coding procedure includes a MLC procedure.

### BRIEF DESCRIPTION OF THE DRAWINGS

FIGS. 1 and 2 illustrate examples of wireless communications systems that support dynamic reporting of a multi-level coding (MLC) configurations in accordance with one or more aspects of the present disclosure.

FIG. 3 illustrates an example of a process flow that supports dynamic reporting of MLC configurations in accordance with one or more aspects of the present disclosure.

FIGS. 4 and 5 show block diagrams of devices that support dynamic reporting of MLC configurations in accordance with one or more aspects of the present disclosure.

FIG. 6 shows a block diagram of a communications manager that supports dynamic reporting of MLC configurations in accordance with one or more aspects of the present disclosure.

FIG. 7 shows a diagram of a system including a device that supports dynamic reporting of MLC configurations in accordance with one or more aspects of the present disclosure.

FIGS. 8 and 9 show block diagrams of devices that support dynamic reporting of MLC configurations in accordance with one or more aspects of the present disclosure.

FIG. 10 shows a block diagram of a communications manager that supports dynamic reporting of MLC configurations in accordance with one or more aspects of the present disclosure.

FIG. 11 shows a diagram of a system including a device that supports dynamic reporting of MLC configurations in accordance with one or more aspects of the present disclosure.

FIGS. 12 through 17 show flowcharts illustrating methods that support dynamic reporting of MLC configurations in accordance with one or more aspects of the present disclosure.

### DETAILED DESCRIPTION

A wireless device, such as a user equipment (UE), may support various different modulation and coding procedures to generate, from a set of information bits, one or more data symbols for a transmission. The available coding procedures associated with the set of available modulation and coding procedures may provide different levels of error-protection to each bit (e.g., binary bit) that represents a data symbol generated in accordance with a symbol constellation. A UE may implement various types of coding procedures such as low-density parity check (LDPC) coding to perform channel encoding and decoding. In some cases, however, these types of channel coding procedures utilize costly power resources (e.g., may consume power above a threshold power level), which may reduce battery life.

To reduce power consumption, devices may perform different kinds of coding procedures such as multi-level coding (MLC) procedures. In MLC, encoding and decoding may be split into multiple levels such that different component codes (e.g., code rates or modulation orders) are applied to sets of bits (e.g., non-overlapping sets of bits). To perform multiple levels of coding, the UE may select a channel quality indicator (CQI) index which corresponds to a modulation order and a coding scheme for each level of code. As MLC constitutes at least two levels of code, the quantity of possible MCS combinations is extensive (e.g., may exceed a threshold) because the selected CQI index corresponds to modulation orders and coding schemes for each level of code for MLC.

In some examples, to report CQI more efficiently to select modulation order and coding rate values for MLC, the UE may select and report one CQI value per code level of the MLC procedure (e.g., instead of sending a single CQI value to select both modulation order and code rate values). For example, for a first coding level, the UE may select a first CQI index associated with a first modulation order and first coding rate from a first CQI table, and then for a second coding level the UE may select a second CQI index associated with a second coding rate from a second CQI table. The UE may send the selected indices in a UE report such as a channel state information (CSI) report to the network and may receive subsequent control signaling from the network indicating which CQI indices are selected and which corresponding modulation and coding scheme (MCS) values to use for each level of MLC. By separately selecting CQI values for each code level, the UE may effectively be able to increase spectral efficiency and reduce power consumption associated with the MLC procedure.

Aspects of the disclosure are initially described in the context of wireless communications systems. Aspects of the disclosure are further illustrated by and described with reference to a process flow, apparatus diagrams, system diagrams, and flowcharts that relate to dynamic reporting of MLC configurations.

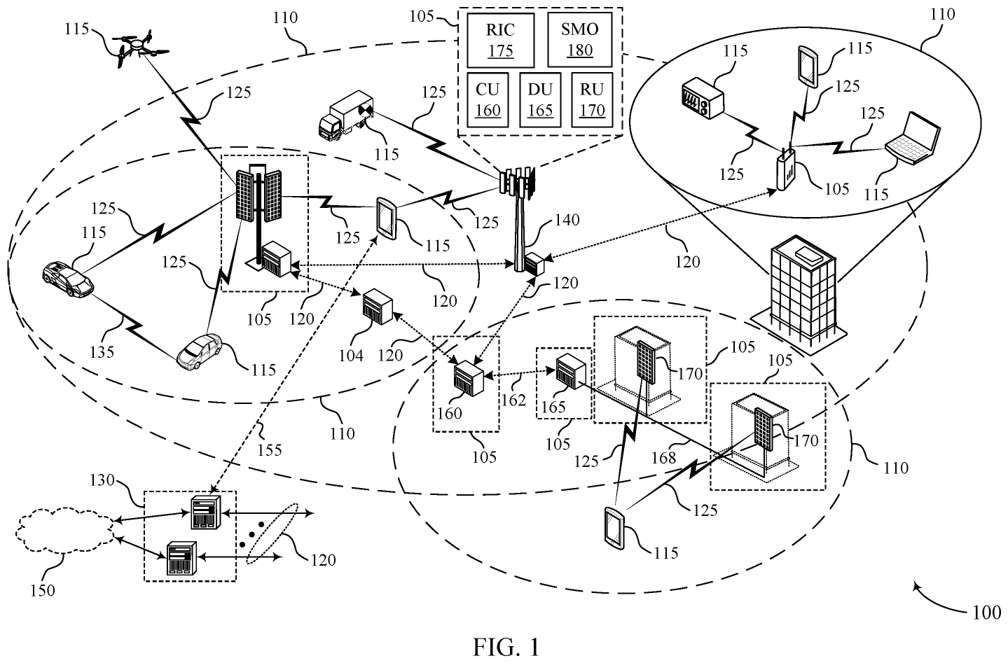

FIG. 1 illustrates an example of a wireless communications system 100 that supports dynamic reporting of MLC configurations in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support dynamic reporting of MLC configurations as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MIME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

A wireless communications system 100 may support procedures for estimating characteristics of a channel. In some examples, reference signals are communicated between wireless devices and used to determine characteristics (e.g., timing, frequency, or attenuation characteristics) of a channel between the wireless devices. Reference signals may include channel state information (CSI) reference signals (RS) (CSI-RS), demodulation reference signals (DMRS), sounding reference signals (SRS), tracking reference signal (TRS), phase tracking reference signals (PTRS), and the like. A wireless device (e.g., UE) may receive, from another wireless device (e.g., a network entity), a reference signal and use the received version of the reference signal and the transmitted version of the reference signal (which may be known to the wireless device) to determine characteristics (e.g., signal quality, Doppler frequency, a power delay profile, delay spread, and the like) of the channel over which the reference signal was transmitted. The wireless device may use the estimated channel to determine transmission parameters that are well-suited for the channel (e.g., a preferred precoding matrix and rank).

The wireless device may use the estimated channel to determine additional transmission parameters (e.g., a preferred MCS) based on the other transmission parameters. In some examples, the wireless device uses the estimated channel and, in some examples, one or more determined transmission parameters to determine a spectral efficiency (e.g., throughput that can be conveyed by a link using allocated resources) that is obtainable for the channel. In some examples, the preferred MCS may be determined based on the determined spectral efficiency.

After determining preferred transmission parameters for the estimated channel, the wireless device may transmit an indication of the preferred transmission parameters to the other wireless device. In some examples, the wireless device may generate a report including the indication of the preferred transmission parameters, which may be referred to as a channel state feedback (CSF) report. The CSF report may include a CQI, a precoding matrix indicator (PMI), a rank indicator (RI), a beam indicator (CRI), and the like. A value of the CQI may be based on the spectral efficiency obtainable for the channel. In some examples, the value of the CQI is selected using a table that maps CQI indices to spectral efficiency values and MCSs. For example, for a first calculated spectral efficiency, the wireless device may indicate a first CQI index, for a second calculated spectral efficiency, the wireless device may indicate a second CQI index, and so on. Each index of the CQI may be associated with a MCS. For example, a first index may be associated with a first modulation (e.g., 16-quadrature amplitude modulation (QAM)) and a first coding rate (e.g., a 0.438 coding rate), a second index may be associated with the same or a different modulation (e.g., 16-QAM or 64-QAM) and a second coding rate (e.g., a .587 coding rate if the second index is associated with 16-QAM or a 0.369 coding rate if the second index is associated with 64-QAM), and so on.

The other wireless device may receive the indication of the preferred transmission parameters and may use the indicated transmission parameters (or related transmission parameters) for subsequent communications to the wireless device. In some examples, the other wireless device may select a MCS based on the value of the CQI. For example, if the first index is indicated by the CQI, the other wireless device may use the first modulation (e.g., 16-QAM) and the first coding rate (e.g., a 0.438 coding rate) for subsequent transmissions to the wireless device.

Wireless devices such as UE s115 and network entities 105 may support various types of modulation and coding procedures to provide different levels of error-protection for encoded transmissions. For example, the devices may implement LDPC coding to perform channel encoding and decoding. But in some cases, this type of channel coding utilizes a significant amount of power (e.g., an amount of power above a threshold). To reduce power consumption, devices may perform different types of coding procedures such as MLC, where encoding and decoding may be split into multiple levels such that different component codes (e.g., code rates or modulation orders) are applied to non-overlapping sets of bits. To perform MLC, a UE 115 may select a CQI index which corresponds to a modulation order and a coding scheme for each level of code. But since MLC constitutes at least two levels of code, the quantity of possible MCS combinations is extensive since the selected CQI index would correspond to modulation orders and coding schemes for each level of code for MLC.

To report CQI more efficiently to select modulation order and coding rate values for MLC, the UE 115 may select and report one CQI value per code level of the MLC procedure (e.g., instead of sending a single CQI value to select both modulation order and code rate values). For example, for a first coding level, the UE 115 may select a first CQI index associated with a first modulation order and first coding rate from a first CQI table, and then for a second coding level the UE may select a second CQI index associated with a second coding rate from a second CQI table. The UE report the selected CQI indices to a network entity 105 and may receive subsequent control signaling from the network indicating which CQI indices are selected and which corresponding MCS values to use for each level of MLC.

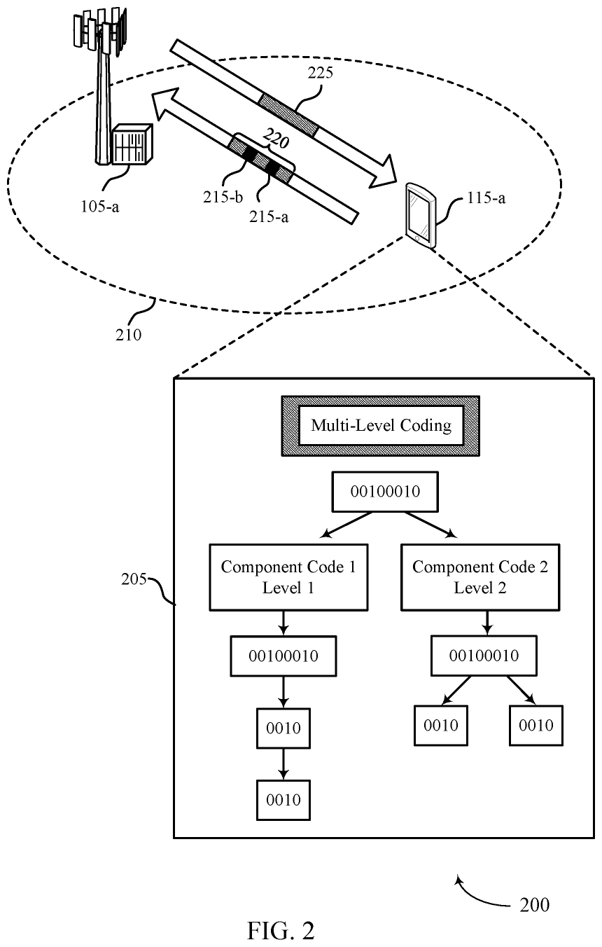

FIG. 2 illustrates an example of a wireless communications system 200 that supports dynamic reporting of MLC configurations in accordance with one or more aspects of the present disclosure. For example, FIG. 2 may illustrate communications between a UE 115-a and a network entity 105-a, which may be examples of corresponding devices described with reference to FIG. 1.

The wireless communications system 200 may support a set of modulation and coding procedures for communicating information between wireless devices such as the UE 115-a and the network entity 105-a in a wireless coverage area 210. Different modulation procedures (e.g., PSK, QAM, etc.) may be used to convert sets of information bits into unique data symbols. Different coding procedures may be used to protect information bits against errors that may occur during transmission of the information bits. In some examples, a wireless communications system 200 may support decoding of the channel code with an low density parity-check coding (LDPC) scheme, which is a linear error correcting code which may be decoded in time linear to code block length. In some cases, however, LDPC decoding is complex and relatively power-consuming for the UE to perform for the downlink reception processes. For example, in some implementations, LDPC power consumption in a SubThz downlink band may account for a relative majority of the total power consumption of a device modem (e.g., the power consumed by LDPC coding may reach up to 90% of the overall power consumption).

Such increased power expenditure for LDPC coding is amplified for systems that support increased bandwidth (e.g., 5G NR systems or other high frequency systems). In addition, the power expenditure may become even more prominent with continued growth of bandwidth in wireless systems (e.g., for the SubThz band) where the data rates and bit rates may increase substantially relative to other lower bandwidth systems.

To reduce overall power expenditure for decoding, a device may implement one or more different coding procedures. For example, the UE 115-a may implement a MLC procedure 205 to provide error protection while increasing power savings. MLC procedure 205 may provide different levels of error-protection by labeling bits corresponding to different points in a symbol constellation, and thus, to different bits of a transmitted symbol. During the MLC procedure 205, the information bits may be grouped in accordance with a configured modulation procedure, the grouped information bits may be separated into subsets of bits associated with different coding levels, and different component codes may be applied to the different subsets of bits in accordance with the different coding levels. In some examples, each coding level may correspond to different assignments of different component codes for non-overlapping subsets of bits (e.g., the labeling bits corresponding to the points of the symbol constellation may be separated into subsets of labeling bits that are associated with different coding levels, where the different component codes may be associated with the different subsets of labeling bits). The summation of the bits in each of the coding levels may be equal to the quantity of bits included in the original symbol labeling. Accordingly, MLC may result in unequal error protection for different bits because different subsets of bits may be encoded with different component codes that offer varying levels of protection.

Different methods may be used to decode received MLC-based encoded information. One method for decoding MLC-based encoded information is a multi-stage decoding (MSD) procedure. An MSD procedure may involve decoding a first subset of the received MLC-based encoded information in accordance with a first component code and then decoding a second subset of the received MLC-based encoded information in accordance with a second component code and based on the result of decoding the first subset of the received MLC-based encoded information. That is, the MSD procedure may involve decoding the bits associated with the second level after decoding the bits associated with the first level. Another method for decoding MLC-based encoding information is a parallel independent decoding (PID) procedure. A PID procedure may involve decoding each subset of the received MLC-based encoded information associated with each level independently from each other. That is, the decoding of information bits associated with a first encoding level may not be used while decoding the information bits associated with a second encoding level.

In an example, a bit string (e.g., 00100010) of the MLC procedure 205 may be separated into different component codes and corresponding different coding levels. For example, a first coding level (e.g., component code 1, level 1) may implement an MSD decoding procedure, which may include decoding of an MLC level based on the knowledge obtained from the previous levels decoding (partitioning information). In such cases, the bit string 00100010 may be separated into two levels and the partitioned code may be decoded such that the second half of the bit string (0010) is decoded after the first half (0010). In a second coding level, (e.g., component code 2, level 2), the MLC procedure may implement PID, where decoding each MLC level is done independently without applying the knowledge obtained from a previous level decoding (no subset partitioning).

In some examples, the performance of an MLC procedure 205 may be based on the method or technique used to label the points of a symbol constellation, the method used to divide the labeling bits, the methods used to encode the different levels, the quality of the communication channel, or any combination thereof. In some examples, the performance of MLC-based encoded communications may be based on characteristics of the channel over which the MLC-based encoded communication is communicated (e.g., the channel type) and the method used to decode the MLC-based encoded communication. For example, an MSD procedure may increase a performance of MLC-based encoded transmissions that are performed over an additive white Gaussian noise channel (AWGN). A PID procedure may increase a performance of MLC-based encoded transmissions that are performed over a fading channel.

In some examples, the MLC procedure 205 may increase a spectral efficiency of communications relative to other decoding or encoding procedures. For example, the quantity of bits and the selected code rates for each level of MLC code may be dynamically adjusted for different signal to noise ratio (SNR) regions in order to increase the spectral efficiency. Also, when using MLC procedures that include an uncoded lowest level, a power consumption of MLC-based encoded transmissions may be reduced relative to other coding schemes (e.g., especially for large bandwidths).

Thus, to achieve varying levels of error-protection for different bits in a symbol, a wireless communications system 200 may support MLC procedures.

To support the use of MLC procedures, mechanisms (e.g., new signaling, updated signaling, signaling exchanges, etc.) that support the use of MLC procedure 205 may be established. In some examples, a set of CQI indices may be selected for a CQI and that are associated with MLC-based MCSs (and associated MCS tables) may be established. The UE 115-a and a network entity 105-a may exchange capability information which indicates support for MLC procedures. In some examples, the network entity 105-a may indicate that an extended CQI table is activated, which may correspond to an extended MCS table. When MLC procedures are enabled, the UE 115-a may select different CQI and MCS values from respective tables that may be used to indicate the modulation, the overall code rate, the decoding method, a quantity of levels used for the MLC procedure 205, a quantity of bits included in each level, and a code rate for each level.

Since MLC procedures constitute at least two levels of code, however, the quantity of possible MCS combinations may be extensive or exceed a threshold quantity of combinations. In such cases, using a single MCS table for selecting MLC MCS values may be inefficient since a large quantity of combinations of MCS index, modulation order, and coding rate are possible with the multiple levels of code. Thus, to increase the efficiency and decrease the complexity of UE reporting CQI and associated MCS for MLC, a UE 115-a may support configuration and signaling of a UE report (e.g., a CQI report, a PMI report, an RI report) that dynamically requests a desired MLC MCS per coding level by reporting a CQI index 215 per coding level (instead of reporting a single value for CQI to select a desired MCS from an MCS table). In addition, reporting CQI indices 215 and associated MCS per coding level for MLC may allow the network to optimize UE power consumption for current channel conditions and UE hardware when MLC is used to reduce channel decoding power.

In a first reporting configuration, the UE may report a CQI index 215 per code level associated with the MLC configuration in a CSI report 220. In such cases, each CQI value corresponds to a different MCS (e.g., instead of sending a single CQI value to select multiple MCS values from a selected MCS table). The selection of CQI per code level may increase both spectral efficiency and power consumption of the UE.

Tables 1 and 2 illustrate examples of possible CQI indices and corresponding modulation order and code rates that may be selected for a two-level MLC procedure:

TABLE 1
Index for level 1

| Index for Level 1 | Modulation Order | Code Rate |
|---|---|---|
| 0 | 2 | 0.3 |
| 1 | 2 | 0.44 |
| 2 | 2 | 0.59 |
| 3 | 4 | 0.37 |
| 4 | 4 | 0.42 |
| 5 | 4 | 0.48 |
| 6 | 4 | 0.54 |
| 7 | 4 | 0.6 |

The UE 115-a may select a first CQI index 215-a for level 1 of the MLC procedure using Table 1, which may correspond to a modulation order and code rate. The UE 115-a may then select a second CQI index 215-b for level 2 of the MLC procedure using Table 2, below.

TABLE 2
Index for level 2

| Index for Level 2 | Code Rate |
|---|---|
| 0 | 0.8 |
| 1 | 0.85 |
| 2 | 0.9 |
| 3 | 0.95 |

The second CQI index 215-b may correspond to a code rate. In some examples, Table 1 and Table 2 may be different sizes (e.g., Table 1 and Table 2 may have a different quantity of columns, a different quantity of rows or both), or may be the same size. In some cases, the UE 115-a may select different combinations of indices based on power savings. For example, different combinations of indices may result in the same spectral efficiency but may have different levels of power savings, and the UE 115-a may select a combination of indices 215 for level 1 and level 2 which results in a relatively highest amount of power savings for the UE 115-a.

In a second reporting configuration, the UE 115-a may report an explicit (e.g., quantized) vector or rates for each coding level associated with the MLC configuration in a CSI report 220. In such cases, the UE 115-a may report a quantized value of the MCS (e.g., different quantized values for code rate and modulation order for different CQI indices 215). The UE 115-a may select the quantized values using a set of tables. Table 3, Table 4 and Table 5 illustrate examples of possible CQI indices 215 and corresponding quantized values for code rate and modulation order that may be selected for a two-level MLC procedure:

TABLE 3
Index for level 1

| Index for Level 1 | Code Rate |
|---|---|
| 0 | 0.3 |
| 1 | 0.44 |
| 2 | 0.59 |
| 3 | 0.65 |
| 4 | 0.72 |
| 5 | 0.8 |
| 6 | 0.86 |
| 7 | 0.92 |

TABLE 4
Index for level 2

| Index for Level 2 | Code Rate |
|---|---|
| 0 | 0.8 |
| 1 | 0.85 |
| 2 | 0.9 |
| 3 | 0.95 |

TABLE 5
Index for level 2

| Index for Level 2 | Modulation Order |
|---|---|
| 0 | 2 |
| 1 | 4 |
| 2 | 6 |
| 3 | 8 |

The UE 115-a may select a first CQI index for level 1 of the MLC procedure using Table 3, which may correspond to a code rate. The UE 115-a may then select a second CQI index for level 2 of the MLC procedure using Table 4, which may correspond to a code rate for level 2. The UE 115-a may select a CQI index for level 2 of the MLC procedure using Table 5, which may correspond to a modulation order for level 2. In some examples, Table 3, Table 4, and Table 5 may be different sizes (e.g., Table 3, Table 4, and Table 5 may have a different quantity of columns, a different quantity of rows or both), or may be the same size. In some cases, the UE may select different combinations of indices based on power savings. For example, different combinations of indices may result in the same spectral efficiency but may have different levels of power savings, and the UE may select a combination of indices for level 1 and level 2 which results in a relatively highest amount of power savings for the UE.

The network may activate MLC procedures for transmissions to the UE 115-a based on the received CQI indices received from UE 115-a. In some examples, a network entity may indicate to UE 115-a that the MLC procedures have been activated (e.g., by indicating a CQI index associated with an MLC procedure in a downlink control information (DCI) message 225 sent to the UE). In some examples, the network entity 105-a may indicate that the MLC procedures have been activated (or enabled) by transmitting a DCI message, an RRC message, or a MAC-CE that configures UE 115-a to use MLC procedures. In some other examples, the network entity may transmit a modified DCI to indicate the selected CQI indices that determine the MLC MCS. In some implementations, the network entity may report different MLC MCS indices based on reporting time granularity. For example, modulation order may be modified at a lower frequency more frequently than other indices controlling the rates of the different coding levels. The dynamic reporting of CQI for MLC may decrease complexity and may increase power savings at the UE 115-a. Additionally, or alternatively, even though the described techniques are related to downlink MLC implementations, the techniques described herein and the configuration of MLC MCS may apply to uplink communications as well.

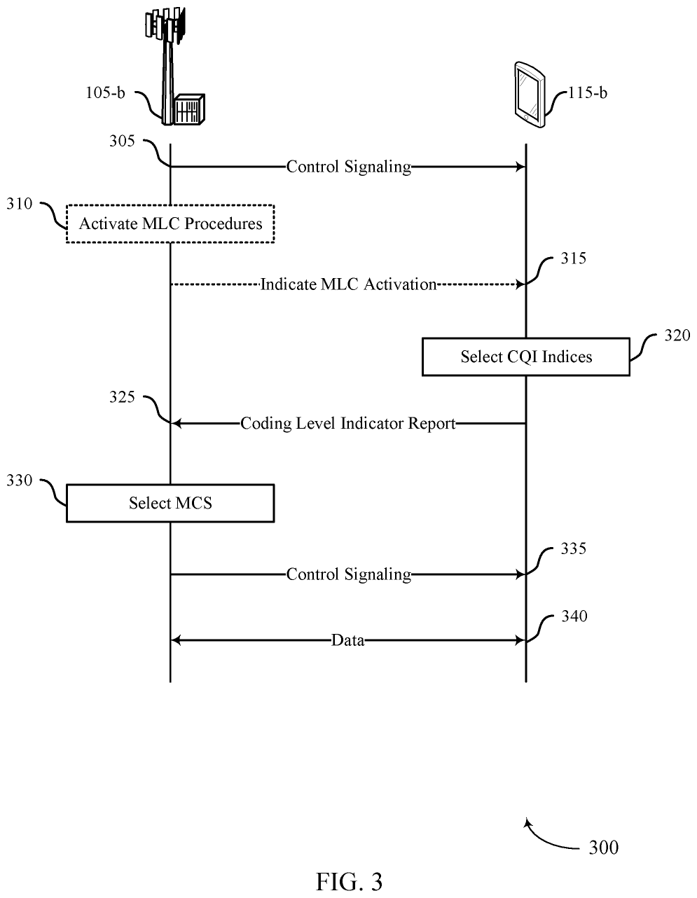

FIG. 3 illustrates an example of a process flow 300 that supports dynamic reporting of MLC configurations in accordance with one or more aspects of the present disclosure. Process flow 300 may be performed by a network entity 105-b and a UE 115-b, which may be examples of network entities and UEs described with reference to FIGS. 1 and 2. In some examples, process flow 300 illustrates an exemplary sequence of operations performed to support dynamic reporting of MLC configurations. It is understood that one or more of the operations described in process flow 300 may be performed earlier or later in the process, omitted, replaced, supplemented, or combined with another operation. Also, additional operations described herein that are not included in process flow 300 may be included in process flow 300.

At 305, the UE 115-b may receive a message that indicates a coding procedure for communications associated with the UE 115-b.

At 310, the network entity 105-b may activate multi-level coding procedures for communicating with the UE 115-b, and at 315 the network entity 105-b may optionally signal an indication of an activation of an MLC procedure to the UE 115-b

At 320, the UE 115-b may select a first code rate indicator value of the plurality of code rate indicator values that corresponds to a first code rate for a first coding level of the coding procedure. The UE 115-b may also select a second code rate indicator value of the plurality of code rate indicator values that corresponds to a second code rate for a second coding level of the coding procedure. In some examples, the UE 115-b may select the first code rate indicator value and the second code rate indicator value based on a spectral efficiency value for communicating data, a power consumption value for communicating the data, or both. For example, in some cases, the UE 115-b may select the first code rate indicator values and the second code rate indicator value based on the spectral efficiency value satisfying a spectral efficiency threshold and the power consumption value satisfying a power consumption threshold for the coding procedure. In some examples, different combinations of the first code rate indicator value and the second code rate indicator value correspond to different spectral efficiency values and different power consumption values.

In some examples, the UE 115-b may select the first code rate indicator value from a first CQI table. For example, the first CQI table may include the plurality of code rate indicator values associated with the first coding level, a first set of one or more corresponding modulation orders, a first set of one or more corresponding code rates, or any combination thereof. The UE 115-b may also select the second code rate indicator value from a second CQI table which includes the plurality of code rate indicator values associated with the second coding level and a second set of one or more corresponding code rates. In some cases, the first CQI table and the second CQI table may have a different quantity of rows and columns based on the first coding level and the second coding level.

In some examples, the UE 115-b may select the first code rate indicator value from a first CQI table that includes a plurality of code rate indicator values associated with the first coding level and a first set of corresponding code rates. The UE 115-b may then select the second code rate indicator value from a second CQI table that includes the plurality of code rate indicator values associated with the second code rate, and a second set of one or more corresponding code rates. The UE 115-b may also select a third code rate indicator value from a third CQI table that includes a modulation order associated with the first code rate indicator value and the second code rate indicator value. In such cases, the first CQI table, the second CQI table, and the third CQI table may have a different quantity of rows and columns based on the first coding level and the second coding level.

At 325, the UE 115-b may transmit a coding level indicator report that includes a plurality of code rate indicator values associated with the coding procedure, including the selected first code rate indicator value and the selected second code rate indicator value. In some examples, the coding level indicator report may be a CQI report, a PMI report, an RI report, or other types of UE reports.

At 330, the network entity 105-b may select MCS values corresponding to the selected first code rate indicator and the selected second code rate indicator based on the received coding level indicator report.

At 335, the network entity 105-b may transmit a message to the UE 115-b that indicates the selected CQI indices and associated MCS values based on the coding level indicator report. For example, the UE 115-b may receive one or more control messages (e.g., DCI, MAC-CE, RRC message, etc.) that indicate a set of code rate indicator values for the UE to use, the set of code rate indicator values corresponding to the first code rate for the first coding level of the coding procedure and to the second code rate for the second coding level of the coding procedure. In some other examples, the one or more control messages may be based on a reporting granularity associated with the first code rate and the second code rate.

At 340, the UE 115-b and the network entity 105-b may communicate at least one data packet using the MLC procedure. In some examples, the UE 115-b may encode or decode a first subset of bits in accordance with the first code rate for the first coding level of the coding procedure and may encode or decode a second subset of bits in accordance with the second code rate for the second coding level of the coding procedure.

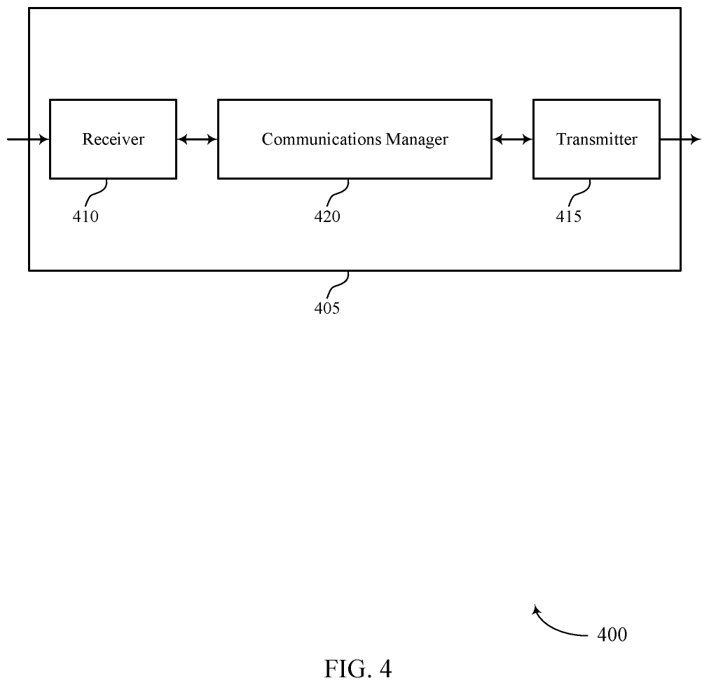

FIG. 4 shows a block diagram 400 of a device 405 that supports dynamic reporting of MLC configurations in accordance with one or more aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to dynamic reporting of MLC configurations). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to dynamic reporting of MLC configurations). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of dynamic reporting of MLC configurations as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication at a UE in accordance with examples as disclosed herein. For example, the communications manager 420 may be configured as or otherwise support a means for receiving a message indicating a coding procedure for communications associated with the UE. The communications manager 420 may be configured as or otherwise support a means for transmitting a coding level indicator report including a set of multiple code rate indicator values associated with the coding procedure, where a first code rate indicator value of the set of multiple code rate indicator values corresponds to a first code rate for a first coding level of the coding procedure, and where a second code rate indicator value of the set of multiple code rate indicator values corresponds to a second code rate for a second coding level of the coding procedure. The communications manager 420 may be configured as or otherwise support a means for communicating at least one data packet using the coding procedure based on the coding level indicator report.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for reduced power consumption and reduced decoding and encoding complexity.

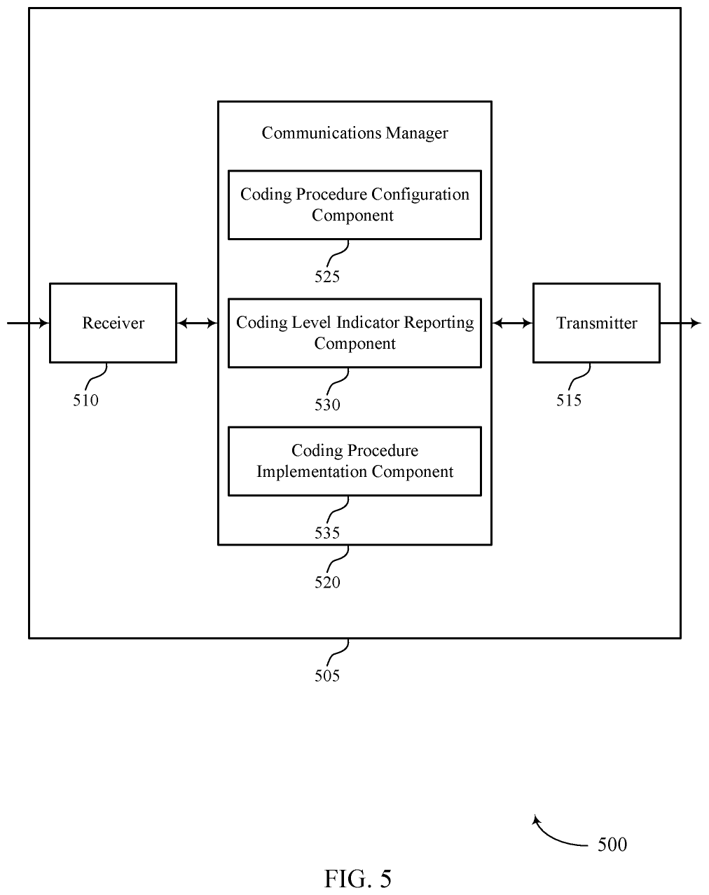

FIG. 5 shows a block diagram 500 of a device 505 that supports dynamic reporting of MLC configurations in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to dynamic reporting of MLC configurations). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to dynamic reporting of MLC configurations). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of dynamic reporting of MLC configurations as described herein. For example, the communications manager 520 may include a coding procedure configuration component 525, a coding level indicator reporting component 530, a coding procedure implementation component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. The coding procedure configuration component 525 may be configured as or otherwise support a means for receiving a message indicating a coding procedure for communications associated with the UE. The coding level indicator reporting component 530 may be configured as or otherwise support a means for transmitting a coding level indicator report including a set of multiple code rate indicator values associated with the coding procedure, where a first code rate indicator value of the set of multiple code rate indicator values corresponds to a first code rate for a first coding level of the coding procedure, and where a second code rate indicator value of the set of multiple code rate indicator values corresponds to a second code rate for a second coding level of the coding procedure.

The coding procedure implementation component 535 may be configured as or otherwise support a means for communicating at least one data packet using the coding procedure based on the coding level indicator report.

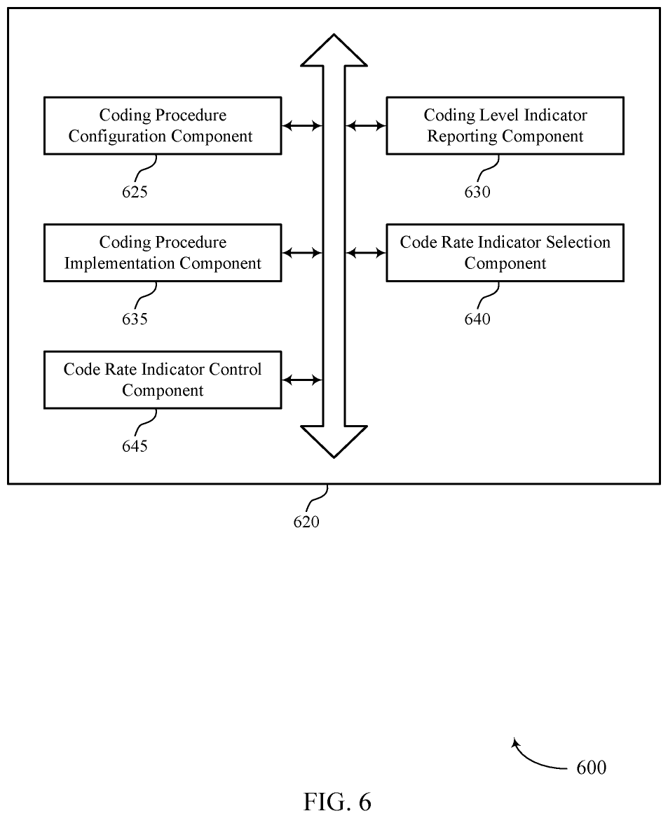

FIG. 6 shows a block diagram 600 of a communications manager 620 that supports dynamic reporting of MLC configurations in accordance with one or more aspects of the present disclosure. The communications manager 620 may be an example of aspects of a communications manager 420, a communications manager 520, or both, as described herein. The communications manager 620, or various components thereof, may be an example of means for performing various aspects of dynamic reporting of MLC configurations as described herein. For example, the communications manager 620 may include a coding procedure configuration component 625, a coding level indicator reporting component 630, a coding procedure implementation component 635, a code rate indicator selection component 640, a code rate indicator control component 645, or any combination thereof. Each of these components may communicate, directly or indirectly, with one another (e.g., via one or more buses).

The communications manager 620 may support wireless communication at a UE in accordance with examples as disclosed herein. The coding procedure configuration component 625 may be configured as or otherwise support a means for receiving a message indicating a coding procedure for communications associated with the UE. The coding level indicator reporting component 630 may be configured as or otherwise support a means for transmitting a coding level indicator report including a set of multiple code rate indicator values associated with the coding procedure, where a first code rate indicator value of the set of multiple code rate indicator values corresponds to a first code rate for a first coding level of the coding procedure, and where a second code rate indicator value of the set of multiple code rate indicator values corresponds to a second code rate for a second coding level of the coding procedure. The coding procedure implementation component 635 may be configured as or otherwise support a means for communicating at least one data packet using the coding procedure based on the coding level indicator report.

In some examples, the code rate indicator selection component 640 may be configured as or otherwise support a means for selecting the first code rate indicator value of the set of multiple code rate indicator values and the second code rate indicator value of the set of multiple code rate indicator values based on a spectral efficiency value for communicating the at least one data packet, a power consumption value for communicating the at least one data packet, or both. In some examples, the coding procedure implementation component 635 may be configured as or otherwise support a means for communicating the at least one data packet using the coding procedure in accordance with the selected first code rate indicator value and the selected second code rate indicator value.

In some examples, the code rate indicator selection component 640 may be configured as or otherwise support a means for selecting the first code rate indicator value and the second code rate indicator value based on the spectral efficiency value satisfying a spectral efficiency threshold and the power consumption value satisfying a power consumption threshold for the coding procedure.

In some examples, different combinations of the first code rate indicator value of the set of multiple code rate indicator values and the second code rate indicator value of the set of multiple code rate indicator values correspond to different spectral efficiency values and different power consumption values.

In some examples, to support communicating the at least one data packet, the coding procedure implementation component 635 may be configured as or otherwise support a means for encoding or decoding a first subset of bits of the at least one data packet in accordance with the first code rate for the first coding level of the coding procedure. In some examples, to support communicating the at least one data packet, the coding procedure implementation component 635 may be configured as or otherwise support a means for encoding or decoding a second subset of bits of the at least one data packet in accordance with the second code rate for the second coding level of the coding procedure.

In some examples, the code rate indicator selection component 640 may be configured as or otherwise support a means for selecting the first code rate indicator value of the set of multiple code rate indicator values from a first CQI table, the first CQI table including the set of multiple code rate indicator values associated with the first coding level, a first set of one or more corresponding modulation orders, a first set of one or more corresponding code rates, or any combination thereof. In some examples, the code rate indicator selection component 640 may be configured as or otherwise support a means for selecting the second code rate indicator value of the set of multiple code rate indicator values from a second CQI table, the second CQI table including the set of multiple code rate indicator values associated with the second coding level, and a second set of one or more corresponding code rates.

In some examples, the first CQI table and the second CQI table have a different quantity of rows and columns based on the first coding level and the second coding level.

In some examples, the code rate indicator selection component 640 may be configured as or otherwise support a means for selecting the first code rate indicator value of the set of multiple code rate indicator values from a first CQI table, the first CQI table including the set of multiple code rate indicator values associated with the first coding level and a first set of corresponding code rates. In some examples, the code rate indicator selection component 640 may be configured as or otherwise support a means for selecting the second code rate indicator value of the set of multiple code rate indicator values from a second CQI table, the second CQI table including the set of multiple code rate indicator values associated with the second code rate, and a second set of one or more corresponding code rates. In some examples, the code rate indicator selection component 640 may be configured as or otherwise support a means for selecting a third code rate indicator value from a third CQI table, the third CQI table including a modulation order associated with the first code rate indicator value and the second code rate indicator value.

In some examples, the first CQI table, the second CQI table, and the third CQI table have a different quantity of rows and columns based on the first coding level and the second coding level.

In some examples, the code rate indicator control component 645 may be configured as or otherwise support a means for receiving, in response to the coding level indicator report, one or more control messages that indicate a set of code rate indicator values for the UE to use, the set of code rate indicator values corresponding to the first code rate for the first coding level of the coding procedure and to the second code rate for the second coding level of the coding procedure.

In some examples, the one or more control messages include a DCI message, a MAC-CE, an RRC message, or any combination thereof.

In some examples, the code rate indicator control component 645 may be configured as or otherwise support a means for receiving the one or more control messages that indicate the set of code rate indicator values based on a reporting granularity associated with the first code rate and the second code rate.

In some examples, the coding level indicator report includes a CQI report, a PMI report, or an RI report.

In some examples, the coding procedure includes a MLC procedure.

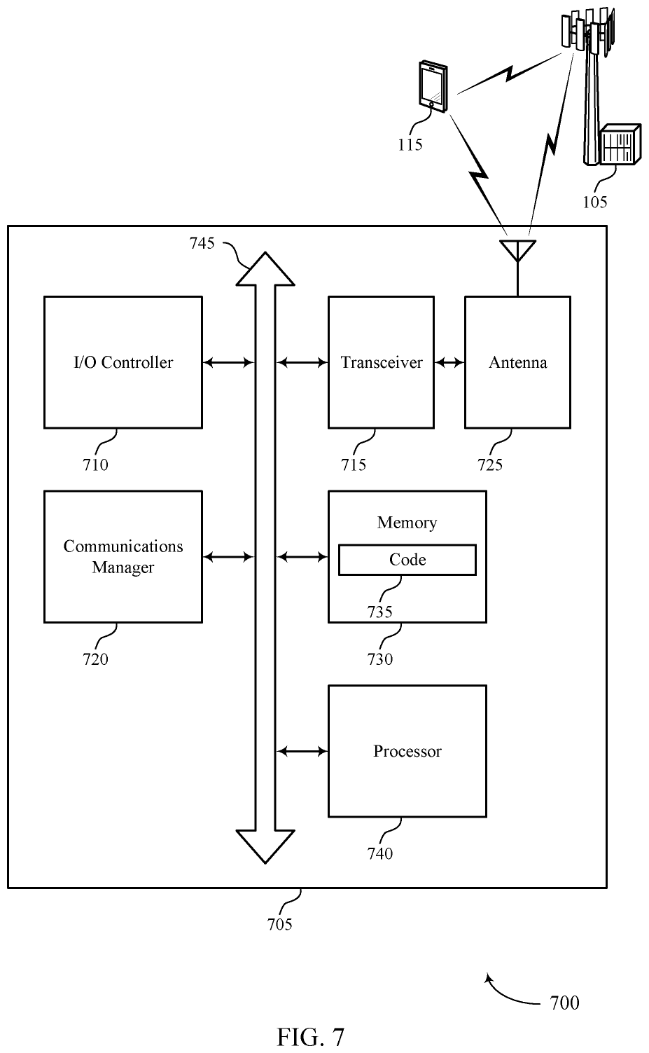

FIG. 7 shows a diagram of a system 700 including a device 705 that supports dynamic reporting of MLC configurations in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/0 controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting dynamic reporting of MLC configurations). For example, the device 705 or a component of the device 705 may include a processor 740 and memory 730 coupled with or to the processor 740, the processor 740 and memory 730 configured to perform various functions described herein.

The communications manager 720 may support wireless communication at a UE in accordance with examples as disclosed herein. For example, the communications manager 720 may be configured as or otherwise support a means for receiving a message indicating a coding procedure for communications associated with the UE. The communications manager 720 may be configured as or otherwise support a means for transmitting a coding level indicator report including a set of multiple code rate indicator values associated with the coding procedure, where a first code rate indicator value of the set of multiple code rate indicator values corresponds to a first code rate for a first coding level of the coding procedure, and where a second code rate indicator value of the set of multiple code rate indicator values corresponds to a second code rate for a second coding level of the coding procedure. The communications manager 720 may be configured as or otherwise support a means for communicating at least one data packet using the coding procedure based on the coding level indicator report.

By including or configuring the communications manager 720 in accordance with examples as described herein, the device 705 may support techniques for increased communication reliability, reduced power consumption, longer battery life, and reduced encoding and decoding complexity.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of dynamic reporting of MLC configurations as described herein, or the processor 740 and the memory 730 may be otherwise configured to perform or support such operations.

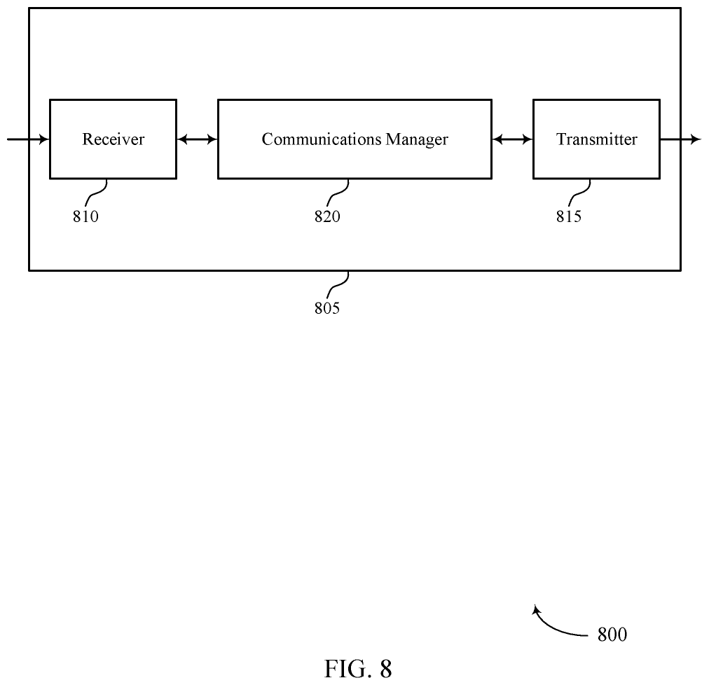

FIG. 8 shows a block diagram 800 of a device 805 that supports dynamic reporting of MLC configurations in accordance with one or more aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of dynamic reporting of MLC configurations as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a network entity in accordance with examples as disclosed herein. For example, the communications manager 820 may be configured as or otherwise support a means for transmitting a message indicating a coding procedure for communications associated with a UE. The communications manager 820 may be configured as or otherwise support a means for receiving, from the UE, a coding level indicator report including a set of multiple code rate indicator values associated with the coding procedure, where a first code rate indicator value of the set of multiple code rate indicator values corresponds to a first code rate for a first coding level of the coding procedure, and where a second code rate indicator value of the set of multiple code rate indicator values corresponds to a second code rate for a second coding level of the coding procedure. The communications manager 820 may be configured as or otherwise support a means for communicating at least one data packet based on the coding level indicator report.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for reduced power consumption and reduced decoding and encoding complexity.

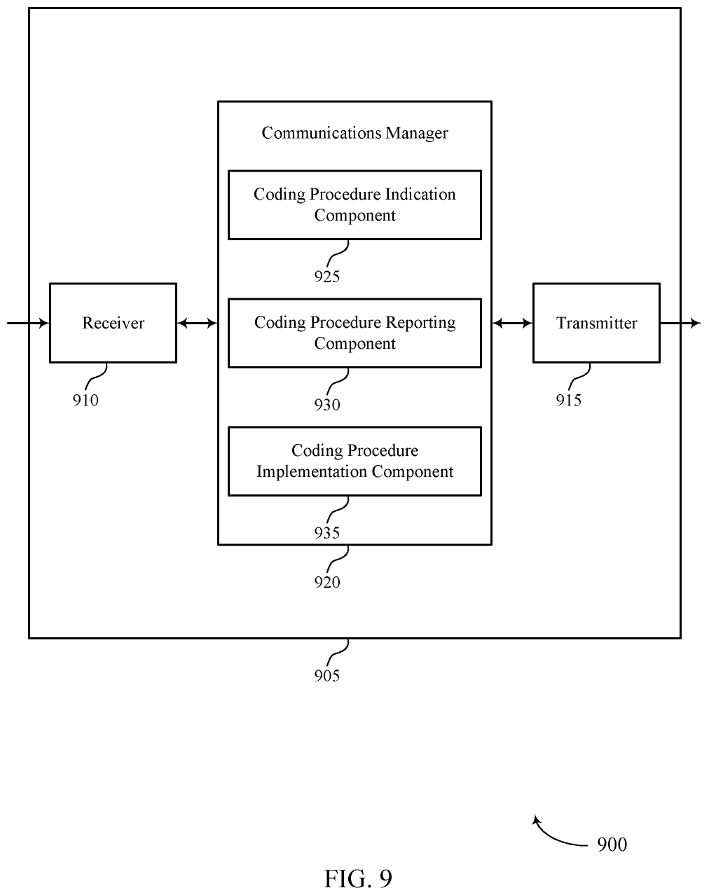

FIG. 9 shows a block diagram 900 of a device 905 that supports dynamic reporting of MLC configurations in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of dynamic reporting of MLC configurations as described herein. For example, the communications manager 920 may include a coding procedure indication component 925, a coding procedure reporting component 930, a coding procedure implementation component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. The coding procedure indication component 925 may be configured as or otherwise support a means for transmitting a message indicating a coding procedure for communications associated with a UE. The coding procedure reporting component 930 may be configured as or otherwise support a means for receiving, from the UE, a coding level indicator report including a set of multiple code rate indicator values associated with the coding procedure, where a first code rate indicator value of the set of multiple code rate indicator values corresponds to a first code rate for a first coding level of the coding procedure, and where a second code rate indicator value of the set of multiple code rate indicator values corresponds to a second code rate for a second coding level of the coding procedure. The coding procedure implementation component 935 may be configured as or otherwise support a means for communicating at least one data packet based on the coding level indicator report.

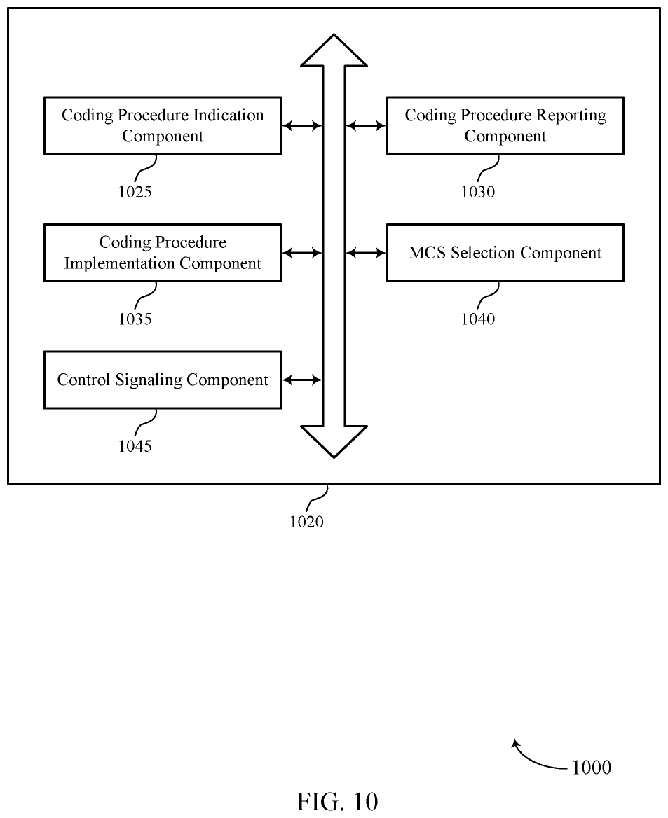

FIG. 10 shows a block diagram 1000 of a communications manager 1020 that supports dynamic reporting of MLC configurations in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of dynamic reporting of MLC configurations as described herein. For example, the communications manager 1020 may include a coding procedure indication component 1025, a coding procedure reporting component 1030, a coding procedure implementation component 1035, an MCS selection component 1040, a control signaling component 1045, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communication at a network entity in accordance with examples as disclosed herein. The coding procedure indication component 1025 may be configured as or otherwise support a means for transmitting a message indicating a coding procedure for communications associated with a UE. The coding procedure reporting component 1030 may be configured as or otherwise support a means for receiving, from the UE, a coding level indicator report including a set of multiple code rate indicator values associated with the coding procedure, where a first code rate indicator value of the set of multiple code rate indicator values corresponds to a first code rate for a first coding level of the coding procedure, and where a second code rate indicator value of the set of multiple code rate indicator values corresponds to a second code rate for a second coding level of the coding procedure. The coding procedure implementation component 1035 may be configured as or otherwise support a means for communicating at least one data packet based on the coding level indicator report.

In some examples, to support communicating the at least one data packet, the coding procedure implementation component 1035 may be configured as or otherwise support a means for encoding or decoding a first subset of bits of the at least one data packet in accordance with the first code rate for the first coding level of the coding procedure. In some examples, to support communicating the at least one data packet, the coding procedure implementation component 1035 may be configured as or otherwise support a means for encoding or decoding a second subset of bits of the at least one data packet in accordance with the second code rate for the second coding level of the coding procedure.

In some examples, the MCS selection component 1040 may be configured as or otherwise support a means for selecting a first set of one or more modulation orders and a first set of one or more code rates for the first coding level. In some examples, the MCS selection component 1040 may be configured as or otherwise support a means for selecting a second set of one or more modulation orders and a second set of one or more code rates for the second coding level. In some examples, the coding procedure reporting component 1030 may be configured as or otherwise support a means for transmitting an indication of the first set of one or more modulation orders for the first coding level, the first set of one or more code rates for the first coding level, the second set of one or more modulation orders for the second coding level, the second set of one or more code rates for the second coding level, or any combination thereof.

In some examples, the coding procedure implementation component 1035 may be configured as or otherwise support a means for encoding or decoding at least one data packet in accordance with the first set of one or more modulation orders for the first coding level, the first set of one or more code rates for the first coding level, the second set of one or more modulation orders for the second coding level, the second set of one or more code rates for the second coding level, or any combination thereof.

In some examples, the control signaling component 1045 may be configured as or otherwise support a means for transmitting, in response to the coding level indicator report, one or more control messages that indicate a set of code rate indicator values for the UE to use, the set of code rate indicator values corresponding to the first code rate for the first coding level of the coding procedure and to the second code rate for the second coding level of the coding procedure.

In some examples, the one or more control messages include a DCI message, a MAC-CE, an RRC message, or any combination thereof.

In some examples, the control signaling component 1045 may be configured as or otherwise support a means for transmitting the one or more control messages that indicate the set of code rate indicator values based on a reporting granularity associated with the first code rate and the second code rate.

In some examples, the coding level indicator report includes a CQI report, a PMI report, or an RI report.

In some examples, the coding procedure includes a MLC procedure.

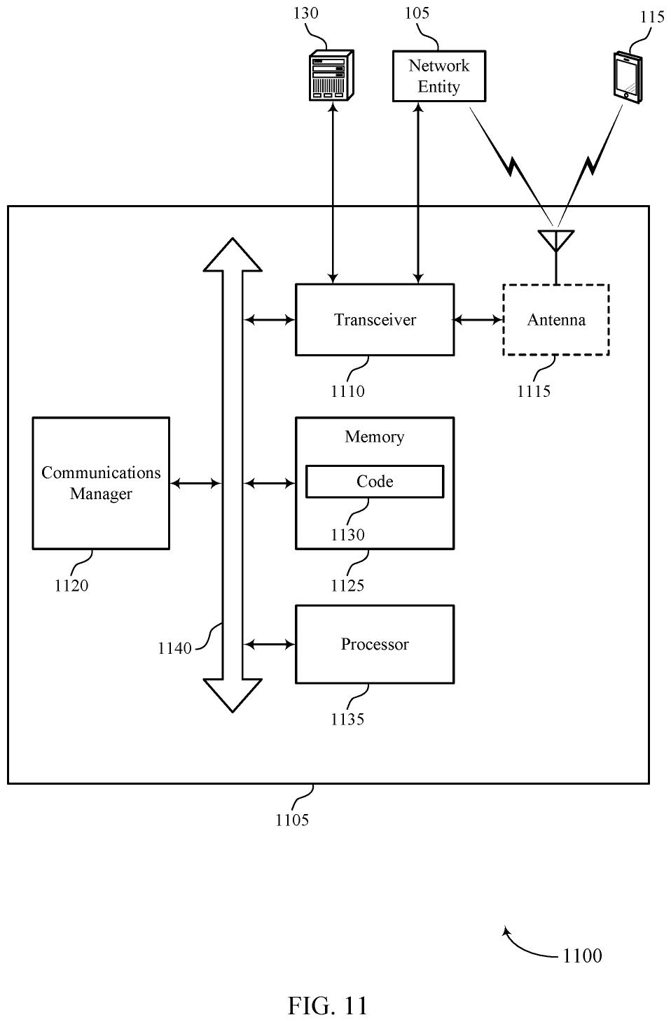

FIG. 11 shows a diagram of a system 1100 including a device 1105 that supports dynamic reporting of MLC configurations in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. The transceiver 1110, or the transceiver 1110 and one or more antennas 1115 or wired interfaces, where applicable, may be an example of a transmitter 815, a transmitter 915, a receiver 810, a receiver 910, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting dynamic reporting of MLC configurations). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and an interface to output information, or to obtain information, or both. The interface may be implemented as or otherwise include a first interface configured to output information and a second interface configured to obtain information. In some implementations, the first interface may refer to an interface between the processing system of the chip or modem and a transmitter, such that the device 1105 may transmit information output from the chip or modem. In some implementations, the second interface may refer to an interface between the processing system of the chip or modem and a receiver, such that the device 1105 may obtain information or signal inputs, and the information may be passed to the processing system. A person having ordinary skill in the art will readily recognize that the first interface also may obtain information or signal inputs, and the second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communication at a network entity in accordance with examples as disclosed herein. For example, the communications manager 1120 may be configured as or otherwise support a means for transmitting a message indicating a coding procedure for communications associated with a UE. The communications manager 1120 may be configured as or otherwise support a means for receiving, from the UE, a coding level indicator report including a set of multiple code rate indicator values associated with the coding procedure, where a first code rate indicator value of the set of multiple code rate indicator values corresponds to a first code rate for a first coding level of the coding procedure, and where a second code rate indicator value of the set of multiple code rate indicator values corresponds to a second code rate for a second coding level of the coding procedure. The communications manager 1120 may be configured as or otherwise support a means for communicating at least one data packet based on the coding level indicator report.

By including or configuring the communications manager 1120 in accordance with examples as described herein, the device 1105 may support techniques for increased communication reliability, reduced power consumption, longer battery life, and reduced encoding and decoding complexity.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the processor 1135, the memory 1125, the code 1130, the transceiver 1110, or any combination thereof. For example, the code 1130 may include instructions executable by the processor 1135 to cause the device 1105 to perform various aspects of dynamic reporting of MLC configurations as described herein, or the processor 1135 and the memory 1125 may be otherwise configured to perform or support such operations.

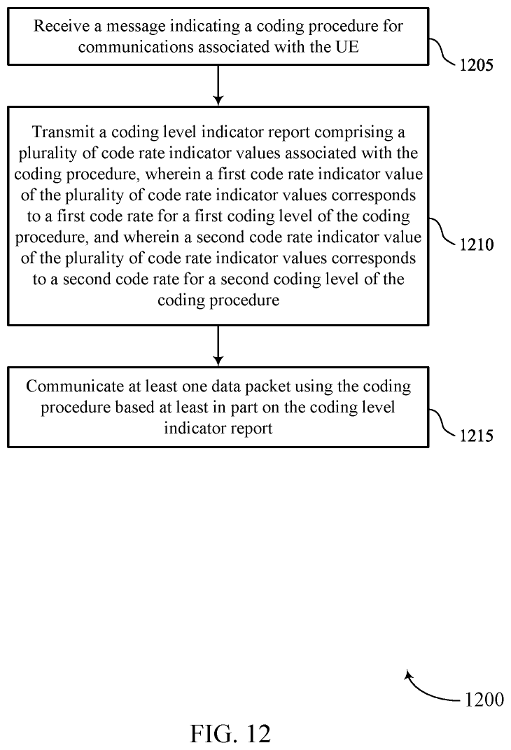

FIG. 12 shows a flowchart illustrating a method 1200 that supports dynamic reporting of MLC configurations in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving a message indicating a coding procedure for communications associated with the UE. The operations of 1205 may be performed in accordance with examples as disclosed herein. In some examples, aspects of the operations of 1205 may be performed by a coding procedure configuration component 625 as described with reference to FIG. 6.

At 1210, the method may include transmitting a coding level indicator report including a set of multiple code rate indicator values associated with the coding procedure, where a first code rate indicator value of the set of multiple code rate indicator values corresponds to a first code rate for a first coding level of the coding procedure, and where a second code rate indicator value of the set of multiple code rate indicator values corresponds to a second code rate for a second coding level of the coding procedure. The operations of 1210 may be performed in accordance with examples as disclosed herein. In some examples, aspects of the operations of 1210 may be performed by a coding level indicator reporting component 630 as described with reference to FIG. 6.

At 1215, the method may include communicating at least one data packet using the coding procedure based on the coding level indicator report. The operations of 1215 may be performed in accordance with examples as disclosed herein. In some examples, aspects of the operations of 1215 may be performed by a coding procedure implementation component 635 as described with reference to FIG. 6.

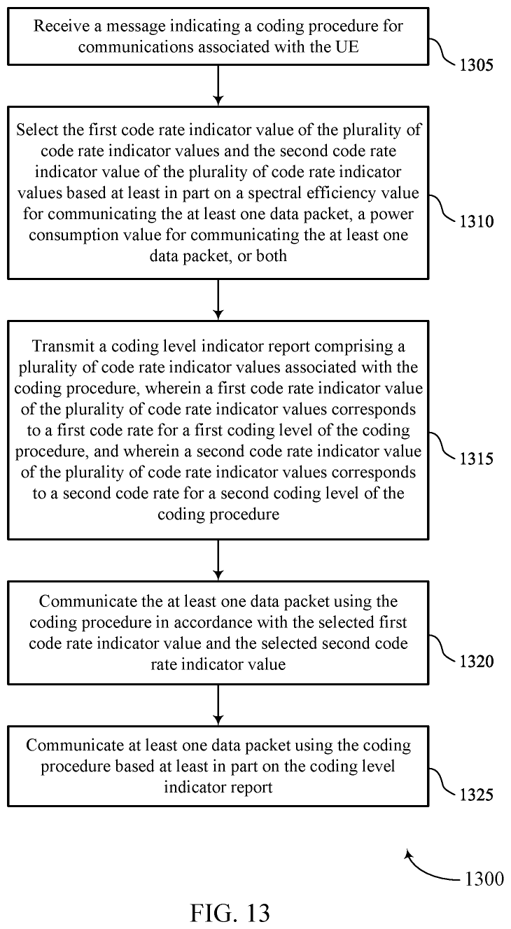

FIG. 13 shows a flowchart illustrating a method 1300 that supports dynamic reporting of MLC configurations in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving a message indicating a coding procedure for communications associated with the UE. The operations of 1305 may be performed in accordance with examples as disclosed herein. In some examples, aspects of the operations of 1305 may be performed by a coding procedure configuration component 625 as described with reference to FIG. 6.

At 1310, the method may include selecting the first code rate indicator value of the set of multiple code rate indicator values and the second code rate indicator value of the set of multiple code rate indicator values based on a spectral efficiency value for communicating the at least one data packet, a power consumption value for communicating the at least one data packet, or both. The operations of 1310 may be performed in accordance with examples as disclosed herein. In some examples, aspects of the operations of 1310 may be performed by a code rate indicator selection component 640 as described with reference to FIG. 6.

At 1315, the method may include transmitting a coding level indicator report including a set of multiple code rate indicator values associated with the coding procedure, where a first code rate indicator value of the set of multiple code rate indicator values corresponds to a first code rate for a first coding level of the coding procedure, and where a second code rate indicator value of the set of multiple code rate indicator values corresponds to a second code rate for a second coding level of the coding procedure. The operations of 1315 may be performed in accordance with examples as disclosed herein. In some examples, aspects of the operations of 1315 may be performed by a coding level indicator reporting component 630 as described with reference to FIG. 6.

At 1320, the method may include communicating the at least one data packet using the coding procedure in accordance with the selected first code rate indicator value and the selected second code rate indicator value. The operations of 1320 may be performed in accordance with examples as disclosed herein. In some examples, aspects of the operations of 1320 may be performed by a coding procedure implementation component 635 as described with reference to FIG. 6.

At 1325, the method may include communicating at least one data packet using the coding procedure based on the coding level indicator report. The operations of 1325 may be performed in accordance with examples as disclosed herein. In some examples, aspects of the operations of 1325 may be performed by a coding procedure implementation component 635 as described with reference to FIG. 6.

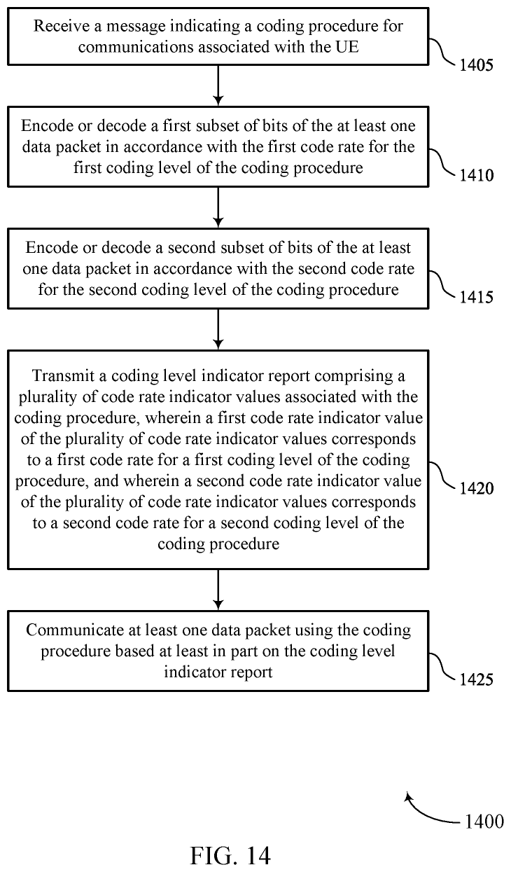

FIG. 14 shows a flowchart illustrating a method 1400 that supports dynamic reporting of MLC configurations in accordance with one or more aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1405, the method may include receiving a message indicating a coding procedure for communications associated with the UE. The operations of 1405 may be performed in accordance with examples as disclosed herein. In some examples, aspects of the operations of 1405 may be performed by a coding procedure configuration component 625 as described with reference to FIG. 6.

At 1410, the method may include encoding or decoding a first subset of bits of the at least one data packet in accordance with the first code rate for the first coding level of the coding procedure. The operations of 1410 may be performed in accordance with examples as disclosed herein. In some examples, aspects of the operations of 1410 may be performed by a coding procedure implementation component 635 as described with reference to FIG. 6.

At 1415, the method may include encoding or decoding a second subset of bits of the at least one data packet in accordance with the second code rate for the second coding level of the coding procedure. The operations of 1415 may be performed in accordance with examples as disclosed herein. In some examples, aspects of the operations of 1415 may be performed by a coding procedure implementation component 635 as described with reference to FIG. 6.

At 1420, the method may include transmitting a coding level indicator report including a set of multiple code rate indicator values associated with the coding procedure, where a first code rate indicator value of the set of multiple code rate indicator values corresponds to a first code rate for a first coding level of the coding procedure, and where a second code rate indicator value of the set of multiple code rate indicator values corresponds to a second code rate for a second coding level of the coding procedure. The operations of 1420 may be performed in accordance with examples as disclosed herein. In some examples, aspects of the operations of 1420 may be performed by a coding level indicator reporting component 630 as described with reference to FIG. 6.

At 1425, the method may include communicating at least one data packet using the coding procedure based on the coding level indicator report. The operations of 1425 may be performed in accordance with examples as disclosed herein. In some examples, aspects of the operations of 1425 may be performed by a coding procedure implementation component 635 as described with reference to FIG. 6.

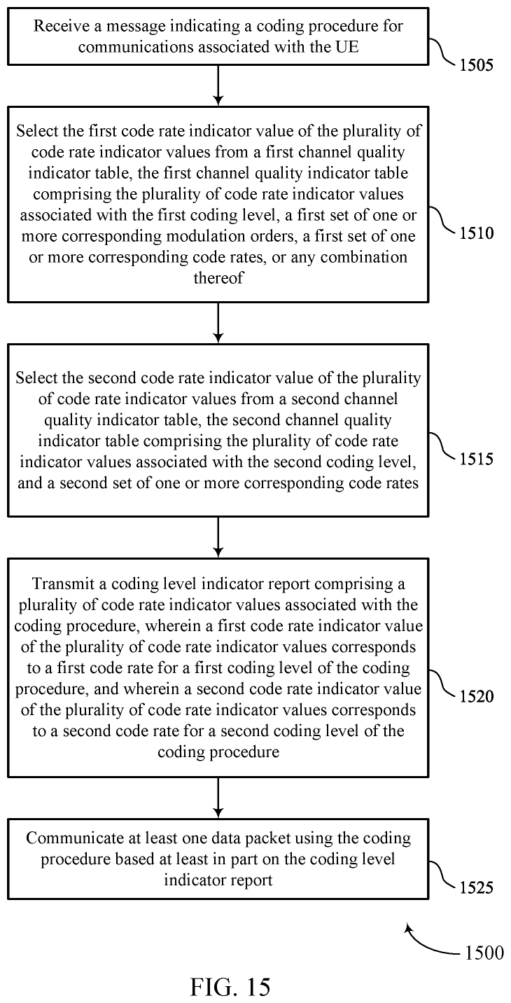

FIG. 15 shows a flowchart illustrating a method 1500 that supports dynamic reporting of MLC configurations in accordance with one or more aspects of the present disclosure. The operations of the method 1500 may be implemented by a UE or its components as described herein. For example, the operations of the method 1500 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1505, the method may include receiving a message indicating a coding procedure for communications associated with the UE. The operations of 1505 may be performed in accordance with examples as disclosed herein. In some examples, aspects of the operations of 1505 may be performed by a coding procedure configuration component 625 as described with reference to FIG. 6.

At 1510, the method may include selecting the first code rate indicator value of the set of multiple code rate indicator values from a first CQI table, the first CQI table including the set of multiple code rate indicator values associated with the first coding level, a first set of one or more corresponding modulation orders, a first set of one or more corresponding code rates, or any combination thereof. The operations of 1510 may be performed in accordance with examples as disclosed herein. In some examples, aspects of the operations of 1510 may be performed by a code rate indicator selection component 640 as described with reference to FIG. 6.

At 1515, the method may include selecting the second code rate indicator value of the set of multiple code rate indicator values from a second CQI table, the second CQI table including the set of multiple code rate indicator values associated with the second coding level, and a second set of one or more corresponding code rates. The operations of 1515 may be performed in accordance with examples as disclosed herein. In some examples, aspects of the operations of 1515 may be performed by a code rate indicator selection component 640 as described with reference to FIG. 6.

At 1520, the method may include transmitting a coding level indicator report including a set of multiple code rate indicator values associated with the coding procedure, where a first code rate indicator value of the set of multiple code rate indicator values corresponds to a first code rate for a first coding level of the coding procedure, and where a second code rate indicator value of the set of multiple code rate indicator values corresponds to a second code rate for a second coding level of the coding procedure. The operations of 1520 may be performed in accordance with examples as disclosed herein. In some examples, aspects of the operations of 1520 may be performed by a coding level indicator reporting component 630 as described with reference to FIG. 6.

At 1525, the method may include communicating at least one data packet using the coding procedure based on the coding level indicator report. The operations of 1525 may be performed in accordance with examples as disclosed herein. In some examples, aspects of the operations of 1525 may be performed by a coding procedure implementation component 635 as described with reference to FIG. 6.

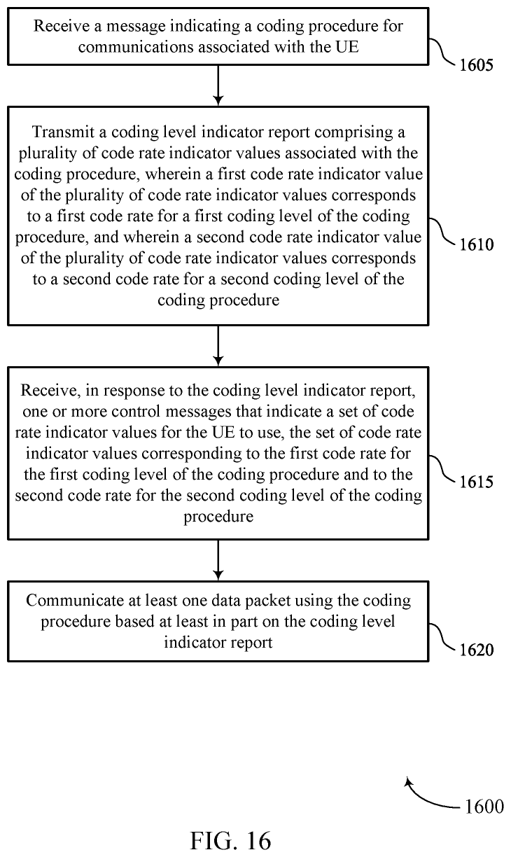

FIG. 16 shows a flowchart illustrating a method 1600 that supports dynamic reporting of MLC configurations in accordance with one or more aspects of the present disclosure. The operations of the method 1600 may be implemented by a UE or its components as described herein. For example, the operations of the method 1600 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1605, the method may include receiving a message indicating a coding procedure for communications associated with the UE. The operations of 1605 may be performed in accordance with examples as disclosed herein. In some examples, aspects of the operations of 1605 may be performed by a coding procedure configuration component 625 as described with reference to FIG. 6.

At 1610, the method may include transmitting a coding level indicator report including a set of multiple code rate indicator values associated with the coding procedure, where a first code rate indicator value of the set of multiple code rate indicator values corresponds to a first code rate for a first coding level of the coding procedure, and where a second code rate indicator value of the set of multiple code rate indicator values corresponds to a second code rate for a second coding level of the coding procedure. The operations of 1610 may be performed in accordance with examples as disclosed herein. In some examples, aspects of the operations of 1610 may be performed by a coding level indicator reporting component 630 as described with reference to FIG. 6.

At 1615, the method may include receiving, in response to the coding level indicator report, one or more control messages that indicate a set of code rate indicator values for the UE to use, the set of code rate indicator values corresponding to the first code rate for the first coding level of the coding procedure and to the second code rate for the second coding level of the coding procedure. The operations of 1615 may be performed in accordance with examples as disclosed herein. In some examples, aspects of the operations of 1615 may be performed by a code rate indicator control component 645 as described with reference to FIG. 6.

At 1620, the method may include communicating at least one data packet using the coding procedure based on the coding level indicator report. The operations of 1620 may be performed in accordance with examples as disclosed herein. In some examples, aspects of the operations of 1620 may be performed by a coding procedure implementation component 635 as described with reference to FIG. 6.

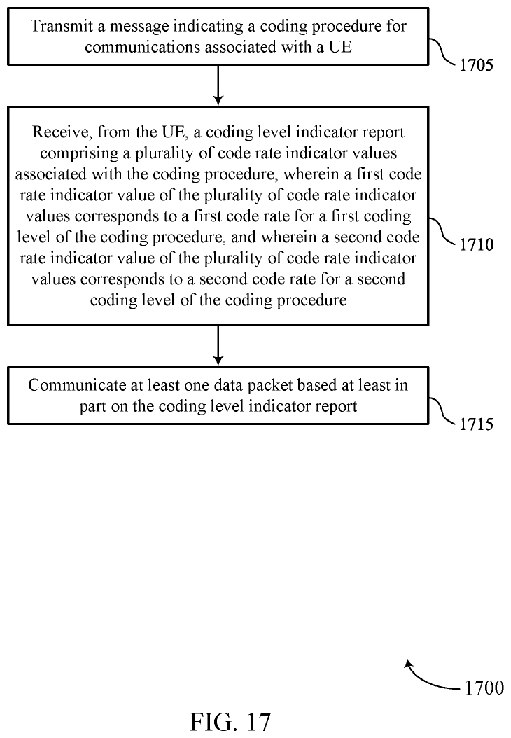

FIG. 17 shows a flowchart illustrating a method 1700 that supports dynamic reporting of MLC configurations in accordance with one or more aspects of the present disclosure. The operations of the method 1700 may be implemented by a network entity or its components as described herein. For example, the operations of the method 1700 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1705, the method may include transmitting a message indicating a coding procedure for communications associated with a UE. The operations of 1705 may be performed in accordance with examples as disclosed herein. In some examples, aspects of the operations of 1705 may be performed by a coding procedure indication component 1025 as described with reference to FIG. 10.

At 1710, the method may include receiving, from the UE, a coding level indicator report including a set of multiple code rate indicator values associated with the coding procedure, where a first code rate indicator value of the set of multiple code rate indicator values corresponds to a first code rate for a first coding level of the coding procedure, and where a second code rate indicator value of the set of multiple code rate indicator values corresponds to a second code rate for a second coding level of the coding procedure. The operations of 1710 may be performed in accordance with examples as disclosed herein. In some examples, aspects of the operations of 1710 may be performed by a coding procedure reporting component 1030 as described with reference to FIG. 10.

At 1715, the method may include communicating at least one data packet based on the coding level indicator report. The operations of 1715 may be performed in accordance with examples as disclosed herein. In some examples, aspects of the operations of 1715 may be performed by a coding procedure implementation component 1035 as described with reference to FIG. 10.

The following provides an overview of aspects of the present disclosure:

Aspect 1: A method for wireless communication at a UE, comprising: receiving a message indicating a coding procedure for communications associated with the UE; transmitting a coding level indicator report comprising a plurality of code rate indicator values associated with the coding procedure, wherein a first code rate indicator value of the plurality of code rate indicator values corresponds to a first code rate for a first coding level of the coding procedure, and wherein a second code rate indicator value of the plurality of code rate indicator values corresponds to a second code rate for a second coding level of the coding procedure; and communicating at least one data packet using the coding procedure based at least in part on the coding level indicator report.

Aspect 2: The method of aspect 1, further comprising: selecting the first code rate indicator value of the plurality of code rate indicator values and the second code rate indicator value of the plurality of code rate indicator values based at least in part on a spectral efficiency value for communicating the at least one data packet, a power consumption value for communicating the at least one data packet, or both; and communicating the at least one data packet using the coding procedure in accordance with the selected first code rate indicator value and the selected second code rate indicator value.

Aspect 3: The method of aspect 2, further comprising: selecting the first code rate indicator value and the second code rate indicator value based at least in part on the spectral efficiency value satisfying a spectral efficiency threshold and the power consumption value satisfying a power consumption threshold for the coding procedure.

Aspect 4: The method of any of aspects 2 through 3, wherein different combinations of the first code rate indicator value of the plurality of code rate indicator values and the second code rate indicator value of the plurality of code rate indicator values correspond to different spectral efficiency values and different power consumption values.

Aspect 5: The method of any of aspects 1 through 4, wherein communicating the at least one data packet comprises: encoding or decoding a first subset of bits of the at least one data packet in accordance with the first code rate for the first coding level of the coding procedure; and encoding or decoding a second subset of bits of the at least one data packet in accordance with the second code rate for the second coding level of the coding procedure.

Aspect 6: The method of any of aspects 1 through 5, further comprising: selecting the first code rate indicator value of the plurality of code rate indicator values from a first channel quality indicator table, the first channel quality indicator table comprising the plurality of code rate indicator values associated with the first coding level, a first set of one or more corresponding modulation orders, a first set of one or more corresponding code rates, or any combination thereof; and selecting the second code rate indicator value of the plurality of code rate indicator values from a second channel quality indicator table, the second channel quality indicator table comprising the plurality of code rate indicator values associated with the second coding level, and a second set of one or more corresponding code rates.

Aspect 7: The method of aspect 6, wherein the first channel quality indicator table and the second channel quality indicator table have a different quantity of rows and columns based at least in part on the first coding level and the second coding level.

Aspect 8: The method of any of aspects 1 through 7, further comprising: selecting the first code rate indicator value of the plurality of code rate indicator values from a first channel quality indicator table, the first channel quality indicator table comprising the plurality of code rate indicator values associated with the first coding level and a first set of corresponding code rates; selecting the second code rate indicator value of the plurality of code rate indicator values from a second channel quality indicator table, the second channel quality indicator table comprising the plurality of code rate indicator values associated with the second code rate, and a second set of one or more corresponding code rates; and selecting a third code rate indicator value from a third channel quality indicator table, the third channel quality indicator table comprising a modulation order associated with the first code rate indicator value and the second code rate indicator value.

Aspect 9: The method of aspect 8, wherein the first channel quality indicator table, the second channel quality indicator table, and the third channel quality indicator table have a different quantity of rows and columns based at least in part on the first coding level and the second coding level.

Aspect 10: The method of any of aspects 1 through 9, further comprising: receiving, in response to the coding level indicator report, one or more control messages that indicate a set of code rate indicator values for the UE to use, the set of code rate indicator values corresponding to the first code rate for the first coding level of the coding procedure and to the second code rate for the second coding level of the coding procedure.

Aspect 11: The method of aspect 10, wherein the one or more control messages comprise a downlink control information message, a medium access control-control element, a radio resource control message, or any combination thereof.

Aspect 12: The method of any of aspects 10 through 11, further comprising: receiving the one or more control messages that indicate the set of code rate indicator values based at least in part on a reporting granularity associated with the first code rate and the second code rate.

Aspect 13: The method of any of aspects 1 through 12, wherein the coding level indicator report comprises a channel quality indicator report, a precoding matrix indicator report, or a rank indicator report.

Aspect 14: The method of any of aspects 1 through 13, wherein the coding procedure comprises a multi-level coding procedure.

Aspect 15: A method for wireless communication at a network entity, comprising: transmitting a message indicating a coding procedure for communications associated with a UE; receiving, from the UE, a coding level indicator report comprising a plurality of code rate indicator values associated with the coding procedure, wherein a first code rate indicator value of the plurality of code rate indicator values corresponds to a first code rate for a first coding level of the coding procedure, and wherein a second code rate indicator value of the plurality of code rate indicator values corresponds to a second code rate for a second coding level of the coding procedure; and communicating at least one data packet based at least in part on the coding level indicator report.

Aspect 16: The method of aspect 15, wherein communicating the at least one data packet comprises: encoding or decoding a first subset of bits of the at least one data packet in accordance with the first code rate for the first coding level of the coding procedure; and encoding or decoding a second subset of bits of the at least one data packet in accordance with the second code rate for the second coding level of the coding procedure.

Aspect 17: The method of any of aspects 15 through 16, further comprising: selecting a first set of one or more modulation orders and a first set of one or more code rates for the first coding level; selecting a second set of one or more modulation orders and a second set of one or more code rates for the second coding level; and transmitting an indication of the first set of one or more modulation orders for the first coding level, the first set of one or more code rates for the first coding level, the second set of one or more modulation orders for the second coding level, the second set of one or more code rates for the second coding level, or any combination thereof.

Aspect 18: The method of aspect 17, further comprising: encoding or decoding at least one data packet in accordance with the first set of one or more modulation orders for the first coding level, the first set of one or more code rates for the first coding level, the second set of one or more modulation orders for the second coding level, the second set of one or more code rates for the second coding level, or any combination thereof.

Aspect 19: The method of any of aspects 15 through 18, further comprising: transmitting, in response to the coding level indicator report, one or more control messages that indicate a set of code rate indicator values for the UE to use, the set of code rate indicator values corresponding to the first code rate for the first coding level of the coding procedure and to the second code rate for the second coding level of the coding procedure.

Aspect 20: The method of aspect 19, wherein the one or more control messages comprise a downlink control information message, a medium access control-control element, a radio resource control message, or any combination thereof.

Aspect 21: The method of any of aspects 19 through 20, further comprising: transmitting the one or more control messages that indicate the set of code rate indicator values based at least in part on a reporting granularity associated with the first code rate and the second code rate.

Aspect 22: The method of any of aspects 15 through 21, wherein the coding level indicator report comprises a channel quality indicator report, a precoding matrix indicator report, or a rank indicator report.

Aspect 23: The method of any of aspects 15 through 22, wherein the coding procedure comprises a multi-level coding procedure.

Aspect 24: An apparatus for wireless communication at a UE, comprising a processor; memory coupled with the processor; and instructions stored in the memory and executable by the processor to cause the apparatus to perform a method of any of aspects 1 through 14.

Aspect 25: An apparatus for wireless communication at a UE, comprising at least one means for performing a method of any of aspects 1 through 14.

Aspect 26: A non-transitory computer-readable medium storing code for wireless communication at a UE, the code comprising instructions executable by a processor to perform a method of any of aspects 1 through 14.

Aspect 27: An apparatus for wireless communication at a network entity, comprising a processor; memory coupled with the processor; and instructions stored in the memory and executable by the processor to cause the apparatus to perform a method of any of aspects 15 through 23.

Aspect 28: An apparatus for wireless communication at a network entity, comprising at least one means for performing a method of any of aspects 15 through 23.

Aspect 29: A non-transitory computer-readable medium storing code for wireless communication at a network entity, the code comprising instructions executable by a processor to perform a method of any of aspects 15 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving a message indicating a coding procedure for communications associated with the UE;
transmitting a coding level indicator report comprising a plurality of code rate indicator values associated with the coding procedure, wherein a first code rate indicator value of the plurality of code rate indicator values corresponds to a first code rate for a first coding level of the coding procedure, and wherein a second code rate indicator value of the plurality of code rate indicator values corresponds to a second code rate for a second coding level of the coding procedure; and
communicating at least one data packet using the coding procedure based at least in part on the coding level indicator report.

2. The method of claim 1, further comprising:
selecting the first code rate indicator value of the plurality of code rate indicator values and the second code rate indicator value of the plurality of code rate indicator values based at least in part on a spectral efficiency value for communicating the at least one data packet, a power consumption value for communicating the at least one data packet, or both; and
communicating the at least one data packet using the coding procedure in accordance with the selected first code rate indicator value and the selected second code rate indicator value.

3. The method of claim 2, further comprising:
selecting the first code rate indicator value and the second code rate indicator value based at least in part on the spectral efficiency value satisfying a spectral efficiency threshold and the power consumption value satisfying a power consumption threshold for the coding procedure.

4. The method of claim 2, wherein different combinations of the first code rate indicator value of the plurality of code rate indicator values and the second code rate indicator value of the plurality of code rate indicator values correspond to different spectral efficiency values and different power consumption values.

5. The method of claim 1, wherein communicating the at least one data packet comprises:
encoding or decoding a first subset of bits of the at least one data packet in accordance with the first code rate for the first coding level of the coding procedure; and
encoding or decoding a second subset of bits of the at least one data packet in accordance with the second code rate for the second coding level of the coding procedure.

6. The method of claim 1, further comprising:
selecting the first code rate indicator value of the plurality of code rate indicator values from a first channel quality indicator table, the first channel quality indicator table comprising the plurality of code rate indicator values associated with the first coding level, a first set of one or more corresponding modulation orders, a first set of one or more corresponding code rates, or any combination thereof; and
selecting the second code rate indicator value of the plurality of code rate indicator values from a second channel quality indicator table, the second channel quality indicator table comprising the plurality of code rate indicator values associated with the second coding level, and a second set of one or more corresponding code rates.

7. The method of claim 6, wherein the first channel quality indicator table and the second channel quality indicator table have a different quantity of rows and columns based at least in part on the first coding level and the second coding level.

8. The method of claim 1, further comprising:
selecting the first code rate indicator value of the plurality of code rate indicator values from a first channel quality indicator table, the first channel quality indicator table comprising the plurality of code rate indicator values associated with the first coding level and a first set of corresponding code rates;
selecting the second code rate indicator value of the plurality of code rate indicator values from a second channel quality indicator table, the second channel quality indicator table comprising the plurality of code rate indicator values associated with the second code rate, and a second set of one or more corresponding code rates; and
selecting a third code rate indicator value from a third channel quality indicator table, the third channel quality indicator table comprising a modulation order associated with the first code rate indicator value and the second code rate indicator value.

9. The method of claim 8, wherein the first channel quality indicator table, the second channel quality indicator table, and the third channel quality indicator table have a different quantity of rows and columns based at least in part on the first coding level and the second coding level.

10. The method of claim 1, further comprising:
receiving, in response to the coding level indicator report, one or more control messages that indicate a set of code rate indicator values for the UE to use, the set of code rate indicator values corresponding to the first code rate for the first coding level of the coding procedure and to the second code rate for the second coding level of the coding procedure.

11. The method of claim 10, wherein the one or more control messages comprise a downlink control information message, a medium access control-control element, a radio resource control message, or any combination thereof.

12. The method of claim 10, further comprising:
receiving the one or more control messages that indicate the set of code rate indicator values based at least in part on a reporting granularity associated with the first code rate and the second code rate.

13. The method of claim 1, wherein the coding level indicator report comprises a channel quality indicator report, a precoding matrix indicator report, or a rank indicator report.

14. The method of claim 1, wherein the coding procedure comprises a MLC procedure.

15. A method for wireless communication at a network entity, comprising:
transmitting a message indicating a coding procedure for communications associated with a user equipment (UE);
receiving, from the UE, a coding level indicator report comprising a plurality of code rate indicator values associated with the coding procedure, wherein a first code rate indicator value of the plurality of code rate indicator values corresponds to a first code rate for a first coding level of the coding procedure, and wherein a second code rate indicator value of the plurality of code rate indicator values corresponds to a second code rate for a second coding level of the coding procedure; and
communicating at least one data packet based at least in part on the coding level indicator report.

16. The method of claim 15, wherein communicating the at least one data packet comprises:
encoding or decoding a first subset of bits of the at least one data packet in accordance with the first code rate for the first coding level of the coding procedure; and
encoding or decoding a second subset of bits of the at least one data packet in accordance with the second code rate for the second coding level of the coding procedure.

17. The method of claim 15, further comprising:
selecting a first set of one or more modulation orders and a first set of one or more code rates for the first coding level;
selecting a second set of one or more modulation orders and a second set of one or more code rates for the second coding level; and
transmitting an indication of the first set of one or more modulation orders for the first coding level, the first set of one or more code rates for the first coding level, the second set of one or more modulation orders for the second coding level, the second set of one or more code rates for the second coding level, or any combination thereof.

18. The method of claim 17, further comprising:
encoding or decoding the at least one data packet in accordance with the first set of one or more modulation orders for the first coding level, the first set of one or more code rates for the first coding level, the second set of one or more modulation orders for the second coding level, the second set of one or more code rates for the second coding level, or any combination thereof.

19. The method of claim 15, further comprising:
transmitting, in response to the coding level indicator report, one or more control messages that indicate a set of code rate indicator values for the UE to use, the set of code rate indicator values corresponding to the first code rate for the first coding level of the coding procedure and to the second code rate for the second coding level of the coding procedure.

20. The method of claim 19, wherein the one or more control messages comprise a downlink control information message, a medium access control-control element, a radio resource control message, or any combination thereof.

21. The method of claim 19, further comprising:
transmitting the one or more control messages that indicate the set of code rate indicator values based at least in part on a reporting granularity associated with the first code rate and the second code rate.

22. The method of claim 15, wherein the coding level indicator report comprises a channel quality indicator report, a precoding matrix indicator report, or a rank indicator report.

23. The method of claim 15, wherein the coding procedure comprises a MLC procedure.

24. An apparatus for wireless communication at a user equipment (UE), comprising:
a processor;
memory coupled with the processor; and
instructions stored in the memory and executable by the processor to cause the apparatus to:
receive a message indicating a coding procedure for communications associated with the UE;
transmit a coding level indicator report comprising a plurality of code rate indicator values associated with the coding procedure, wherein a first code rate indicator value of the plurality of code rate indicator values corresponds to a first code rate for a first coding level of the coding procedure, and wherein a second code rate indicator value of the plurality of code rate indicator values corresponds to a second code rate for a second coding level of the coding procedure; and
communicate at least one data packet using the coding procedure based at least in part on the coding level indicator report.

25. The apparatus of claim 24, wherein the instructions are further executable by the processor to cause the apparatus to:
select the first code rate indicator value of the plurality of code rate indicator values and the second code rate indicator value of the plurality of code rate indicator values based at least in part on a spectral efficiency value for communicating the at least one data packet, a power consumption value for communicating the at least one data packet, or both; and
communicate the at least one data packet using the coding procedure in accordance with the selected first code rate indicator value and the selected second code rate indicator value.

26. The apparatus of claim 25, wherein the instructions are further executable by the processor to cause the apparatus to:
select the first code rate indicator value and the second code rate indicator value based at least in part on the spectral efficiency value satisfying a spectral efficiency threshold and the power consumption value satisfying a power consumption threshold for the coding procedure.

27. The apparatus of claim 25, wherein different combinations of the first code rate indicator value of the plurality of code rate indicator values and the second code rate indicator value of the plurality of code rate indicator values correspond to different spectral efficiency values and different power consumption values.

28. The apparatus of claim 24, wherein the instructions to communicate the at least one data packet are executable by the processor to cause the apparatus to:
encode or decode a first subset of bits of the at least one data packet in accordance with the first code rate for the first coding level of the coding procedure; and
encode or decode a second subset of bits of the at least one data packet in accordance with the second code rate for the second coding level of the coding procedure.

29. The apparatus of claim 24, wherein the instructions are further executable by the processor to cause the apparatus to:
select the first code rate indicator value of the plurality of code rate indicator values from a first channel quality indicator table, the first channel quality indicator table comprising the plurality of code rate indicator values associated with the first coding level, a first set of one or more corresponding modulation orders, a first set of one or more corresponding code rates, or any combination thereof; and
select the second code rate indicator value of the plurality of code rate indicator values from a second channel quality indicator table, the second channel quality indicator table comprising the plurality of code rate indicator values associated with the second coding level, and a second set of one or more corresponding code rates.

30. An apparatus for wireless communication at a network entity, comprising:
a processor;
memory coupled with the processor; and
instructions stored in the memory and executable by the processor to cause the apparatus to:
transmit a message indicating a coding procedure for communications associated with a user equipment (UE);
receive, from the UE, a coding level indicator report comprising a plurality of code rate indicator values associated with the coding procedure, wherein a first code rate indicator value of the plurality of code rate indicator values corresponds to a first code rate for a first coding level of the coding procedure, and wherein a second code rate indicator value of the plurality of code rate indicator values corresponds to a second code rate for a second coding level of the coding procedure; and
communicate at least one data packet based at least in part on the coding level indicator report.
